(19) United States
(12) Patent Application Publication
(10) Pub. No.: US 2026/0288778 A1
(43) Pub. Date: Sep. 24, 2026

(54) SYSTEM

(71) Applicant: SoftBank Group Corp., Tokyo (JP)

(72) Inventor: Tomohiro INOUE, Tokyo (JP)

(73) Assignee: SoftBank Group Corp., Tokyo (JP)

(21) Appl. No.: 19/568,816

(22) Filed: Mar. 17, 2026

(30) Foreign Application Priority Data
Mar. 19, 2025 (JP) 2025-045251

(51) Int. Cl. G06F 16/332; G06F 16/335

(52) U.S. Cl. CPC G06F 16/3326; G06F 16/337

(57) ABSTRACT

A system includes a processor that is configured to receive an inquiry from a user, perform natural language processing using a generative artificial intelligence model on the received inquiry to analyze the received inquiry and generate an appropriate answer or guidance, and recognize an emotion of the user and adjust a method of providing the answer or the guidance based on the recognized emotion.

### CROSS-REFERENCE TO RELATED APPLICATION

This application is based on and claims priority under 35 USC 119 from Japanese Patent Application No. 2025-045251 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional inquiry response systems that employ natural language processing often focus solely on the semantic content of a user's inquiry and generate answers or guidance based only on extracted factual information. Such systems do not sufficiently take into account the emotional state of the user, such as frustration, confusion, anxiety, or urgency, and therefore tend to provide uniform responses regardless of how the user is feeling. As a result, the user may perceive the responses as inappropriate in tone, unhelpful in style, or lacking in empathy, which can reduce user satisfaction and the effectiveness of the communication. Furthermore, while recent generative artificial intelligence models can produce rich natural-language answers, there is a lack of mechanisms for systematically using prompt sentences to analyze the user's intent and extract related information in a robust and controllable manner. In addition, many existing systems do not flexibly adjust the method of providing answers or guidance, for example in terms of content structure, degree of detail, or response style, based on the recognized user emotion. Therefore, there is a need for a system that not only generates appropriate answers or guidance using a generative artificial intelligence model, but also recognizes the user's emotion and adjusts the method of providing the answers or guidance in accordance with the recognized emotion, while reliably analyzing inquiry intent and extracting related information by using prompt sentences.

### SUMMARY

To solve the above problems, an aspect of the present invention provides a system comprising a processor, wherein the processor is configured to receive an inquiry from a user, perform natural language processing using a generative artificial intelligence model on the received inquiry to analyze the received inquiry and generate an appropriate answer or guidance, and recognize an emotion of the user and adjust a method of providing the answer or the guidance based on the recognized emotion. In one embodiment, the processor is further configured to use a prompt sentence to analyze an intent of the inquiry and to extract related information, for example by constructing and supplying a structured prompt to the generative artificial intelligence model so that the model outputs both an interpreted intent and specific related data items. In another embodiment, the processor is configured to provide the generated answer or the generated guidance to the user via the Internet. By combining natural language processing using a generative artificial intelligence model with prompt-based intent analysis and information extraction, and by recognizing the user's emotion and adjusting the provision method accordingly, the system according to the present invention can generate answers or guidance that are not only semantically appropriate but also emotionally adaptive, thereby improving user satisfaction and communication effectiveness.

The term “system” refers to a combination of hardware and software components that cooperatively execute processing, including at least one processor and associated memory, communication interfaces, and programs for implementing the functions described in the claims.

The term “processor” refers to any hardware that executes instructions, including a central processing unit (CPU), a graphics processing unit (GPU), a digital signal processor (DSP), an application-specific integrated circuit (ASIC), a field-programmable gate array (FPGA), or a combination thereof.

The term “user” refers to any human operator or person who inputs an inquiry to the system and receives an answer or guidance from the system.

The term “inquiry” refers to any natural-language input, request, question, or statement provided by the user to the system for the purpose of obtaining an answer, guidance, or other information.

The term “natural language processing” refers to processing that analyzes, interprets, or generates human language expressed in text or speech, including one or more of tokenization, part-of-speech tagging, semantic analysis, intent classification, entity extraction, sentiment analysis, and natural-language generation.

The term “generative artificial intelligence model” refers to a machine-learning model, such as a neural network language model, that generates natural-language text or intermediate representations in response to an input, including but not limited to large language models and sequence-to-sequence models.

The term “appropriate answer or guidance” refers to a natural-language response that is generated by the system based on the content of the user's inquiry and extracted related information, and that is intended to address the user's request, question, or problem in a relevant and useful manner.

The term “emotion of the user” refers to an affective state of the user, such as satisfaction, dissatisfaction, frustration, confusion, anxiety, urgency, calmness, or other emotional conditions, inferred from the user's input, behavior, or associated data.

The term “recognize an emotion of the user” refers to the operation in which the processor determines, estimates, or classifies the user's emotional state based on one or more inputs, such as the linguistic features of the inquiry, metadata, historical interaction data, or external signals.

The term “method of providing the answer or the guidance” refers to a manner or style in which the system outputs the generated answer or guidance to the user, including at least one of wording, tone, degree of politeness, level of detail, structure, modality, or presentation format.

The term “adjust a method of providing the answer or the guidance” refers to modifying at least one aspect of the manner or style of the response output, such as changing the tone, level of detail, length, explanation style, or presentation format, in accordance with the recognized emotion of the user.

The term “prompt sentence” refers to a text string or structured instruction supplied to the generative artificial intelligence model that defines, constrains, or guides how the model analyzes the inquiry, interprets the user's intent, or extracts related information.

The term “analyze an intent of the inquiry” refers to determining a purpose, goal, or type of request expressed by the inquiry, such as asking for opening hours, requesting procedural instructions, or seeking contact information.

The term “related information” refers to data or knowledge items that are relevant to the intent of the inquiry, including but not limited to facility information, procedures, schedules, contact details, or conditions associated with the subject of the inquiry.

The term “provide the generated answer or the generated guidance to the user via the Internet” refers to transmitting the generated answer or guidance from the system to a terminal or client device operated by the user over a communication network that includes the Internet, and causing the answer or guidance to be presented to the user on the terminal or client device.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

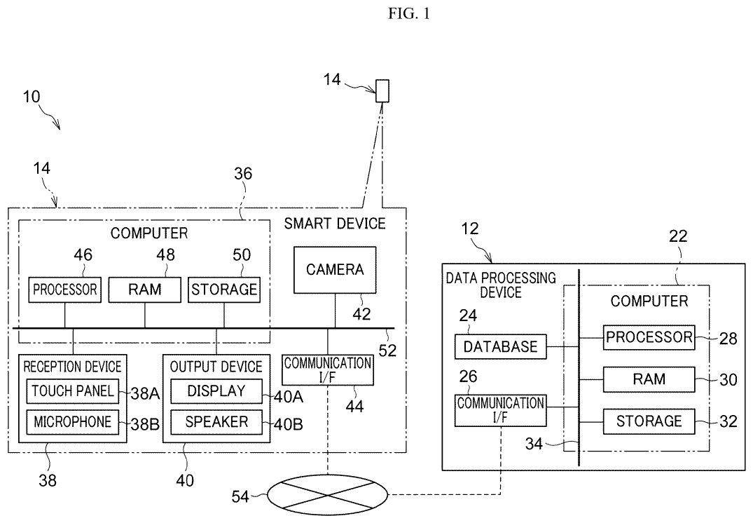

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

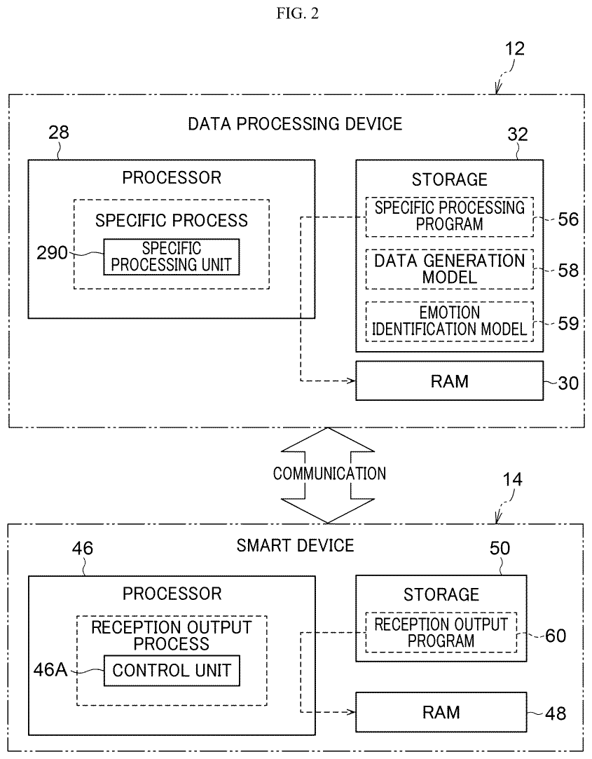

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented inquiry response systems that utilize natural language processing and machine learning often treat user input as isolated text strings and apply a static, one-size-fits-all generation process. As a result, such systems suffer from several technical problems.

First, conventional systems frequently lack a structured pipeline that decomposes incoming text into explicit intermediate representations such as tokenized text, part-of-speech tags, extracted important terms, and intent classifications. Without such structured intermediate data, the systems tend to construct ad hoc prompts for a generative AI model, leading to unstable behavior of the model, inconsistent response quality, and inefficient use of computational resources. In particular, the generative model may process unnecessary or noisy context, which increases processing time and compute load on processors and accelerators, and can produce responses that are irrelevant or verbose.

Second, conventional systems generally do not incorporate systematic, machine-executable control information (for example, generation domain, response style, and output length constraint) into a prompt sentence supplied to a generative AI model. The absence of such control information limits the ability of the system to constrain the generative model's behavior at inference time. Consequently, the system may generate overly long or unfocused responses, which increases network bandwidth consumption when transmitting responses, adds latency for the user, and forces downstream modules to perform additional truncation or filtering.

Third, many known systems do not explicitly estimate and utilize a user's emotional state based on expressions contained in both the incoming inquiry and the generated response. Without this feedback loop, servers are unable to adjust the linguistic tone or structure of the prompt sentence and response text in a machine-controlled manner. This can cause unnecessary back-and-forth communication, increased processor cycles for handling repeated or escalated inquiries, and poor overall system efficiency when dealing with sensitive or emotionally loaded content.

Fourth, existing systems often lack a mechanism to store, in an associated manner, the original inquiry data, the intermediate analysis result data, and the final verified response data as a reusable interaction history. Without such a structured history, the server cannot dynamically update the content of prompt sentences or the operational conditions of the generative model for subsequent inquiries. This results in repeated computation for similar inquiries, inability to leverage past interactions to optimize future processing, and overall reduced throughput and scalability of the server-side computation.

Therefore, there is a need for a computer-implemented system and server-side processing architecture that (i) introduces explicit, structured natural language analysis prior to generative processing, (ii) constructs and enriches a prompt sentence with control information derived from analysis results, (iii) incorporates automated emotion estimation and tone adjustment at the prompt and response levels, and (iv) maintains a history that feeds back into future prompt construction and model configuration. Such a system can improve the technical operation of generative AI-based response engines by stabilizing response behavior, reducing unnecessary computation and network usage, and improving end-to-end efficiency and reliability of the inquiry handling pipeline.

The specific processing by the specific processing unit 290 of the data processing device 12 in Example 1 is realized by the following means.

The present invention provides a server comprising a processor and a storage device, the processor being configured to receive inquiry data transmitted from a user-side information processing apparatus via an electronic communication network, store the inquiry data in the storage device, and execute, by using an analysis program having a natural language processing function, word segmentation processing, part-of-speech tagging processing, important term extraction processing, and intent classification processing on the inquiry data so as to generate analysis result data; to construct, on the basis of the analysis result data and the inquiry data, a prompt sentence to be input to a generative information processing model, to add control information specifying at least one of a generation domain, a response style, and an output length constraint to the prompt sentence on the basis of the analysis result data, and to transmit the prompt sentence with the control information to the generative information processing model so as to cause the generative information processing model to generate response text data; to execute content verification processing and format adjustment processing on the response text data, to estimate an emotional state of a user from an expression included in at least one of the inquiry data and the response text data, and to adjust an expression format of at least one of the prompt sentence and the response text data in accordance with the estimated emotional state; and to store, in association with one another in the storage device, the inquiry data, the analysis result data, and verified response data obtained from the response text data as a history, and dynamically update at least one of contents of a subsequent prompt sentence and an operation condition of the generative information processing model for subsequent inquiry data on the basis of the history. This enables the server to improve the technical operation of a generative AI-based response engine by stabilizing model behavior through structured pre-processing and controlled prompting, reducing computational load and response latency via constrained generation, adapting linguistic output to user emotion in an automated manner to lessen redundant interactions, and reusing historical interaction data to optimize future prompt construction and model configuration, thereby enhancing overall processing efficiency, scalability, and reliability of computer-implemented inquiry handling.

The term “system” refers to an arrangement of one or more machines, devices, and programs that cooperate via hardware and software components to perform processing on data according to predefined procedures.

The term “processor” refers to a hardware computation unit, such as a central processing unit or an execution core, that executes machine instructions to perform arithmetic and logical operations on data.

The term “storage device” refers to a hardware or virtual component, such as a memory device or a non-volatile storage medium, that retains data and program code for access by the processor.

The term “user-side information processing apparatus” refers to a computing device operated by a user, such as a terminal, client device, or communication device, that transmits data to and receives data from a server via a communication network.

The term “electronic communication network” refers to a digital communication infrastructure, such as a packet-switched network or the Internet, that enables electronic transmission and reception of data between distributed devices.

The term “inquiry data” refers to electronic data including a natural language expression of a question, request, or demand provided by a user through a user-side information processing apparatus.

The term “analysis program” refers to software instructions executable by the processor that implement data processing functions, such as natural language processing functions, on the inquiry data.

The term “natural language processing function” refers to a set of computational procedures that enable a computer to analyze, interpret, or transform human language expressions represented as text data.

The term “word segmentation processing” refers to a computational operation that divides text data into smaller units such as tokens or words according to predetermined linguistic rules or models.

The term “part-of-speech tagging processing” refers to a computational operation that assigns grammatical category labels, such as noun, verb, or adjective, to each token within text data.

The term “important term extraction processing” refers to a computational operation that identifies specific words or phrases within text data that are estimated to be informative or relevant for downstream processing.

The term “intent classification processing” refers to a computational operation that assigns an intention label, representing a type of user purpose or goal, to text data based on learned or predefined classification criteria.

The term “analysis result data” refers to structured electronic data generated by the analysis program, including at least one of tokenized text, part-of-speech tags, important terms, and intent classification results.

The term “generative information processing model” refers to a computational model, such as a generative AI model, that receives input data and produces new text data by probabilistic or learned generation of sequences.

The term “prompt sentence” refers to text data supplied to the generative information processing model, the text data including at least one of user-provided content, analysis result data, and control information for guiding generation.

The term “control information” refers to parameter data included in or associated with a prompt sentence that constrains or guides behavior of the generative information processing model with respect to at least one of a generation domain, a response style, and an output length.

The term “generation domain” refers to a specification of a technical field, subject area, or content scope within which the generative information processing model is instructed to generate response text.

The term “response style” refers to a specification of linguistic characteristics of generated text, such as tone, politeness level, level of detail, or format.

The term “output length constraint” refers to a limitation on the amount of generated text, such as a maximum number of tokens, sentences, or characters, imposed on the generative information processing model.

The term “response text data” refers to electronic text data generated by the generative information processing model in response to a prompt sentence.

The term “content verification processing” refers to a computational operation that evaluates response text data for compliance with predetermined criteria, such as relevance, appropriateness, or absence of prohibited expressions.

The term “format adjustment processing” refers to a computational operation that modifies a structure or representation of text data, such as adding punctuation, converting list formats, or adapting layout, without changing essential semantic content.

The term “verified response data” refers to response text data that has passed content verification processing and has been optionally adjusted by format adjustment processing for presentation to a user.

The term “display user interface” refers to a graphical or textual interface, provided by a user-side information processing apparatus, that presents information on a display component and receives user input.

The term “emotional state” refers to an estimated affective condition of a user, such as satisfaction, dissatisfaction, confusion, or urgency, inferred from analysis of textual expressions or related features.

The term “expression format” refers to a configuration of linguistic and structural properties of text, including word choice, sentence structure, tone, and formatting, used to convey content.

The term “history” refers to a set of stored records that associate inquiry data, analysis result data, and verified response data for a plurality of past interactions.

The term “operation condition” refers to one or more parameters or settings that define how the generative information processing model or related processing components operate, such as model selection, parameter values, or control information profiles.

The term “subsequent inquiry data” refers to inquiry data that is received after one or more previous inquiries and that may be processed using information derived from a history of earlier interactions.

In one embodiment, a server, a terminal, and a user cooperate via an electronic communication network to implement the claimed system. The server includes at least one processor, a main memory, a non-volatile storage device, a network interface, and optionally a hardware accelerator such as a graphics processing unit. The server executes operating system software such as a general-purpose server operating system, a web server program, an application server framework, a database management system, a natural language processing library, and a generative AI model library. The terminal includes a processor, a memory, a display device, an input device, and a communication interface, and executes a web browser or a dedicated application.

The server stores a plurality of software modules in the storage device. The server stores a web application module that generates an inquiry input interface, an analysis module that performs natural language processing, a prompt-construction module that builds a prompt sentence, a generative-model interface module that communicates with a generative AI model, an emotion-estimation module that infers a user's emotional state, a verification-and-formatting module that validates and formats response text, and a history-management module that stores and reuses interaction histories. The server stores these modules as executable instructions that the processor loads into main memory for execution.

The terminal presents a user interface that includes at least a text input area and an output display area. The terminal executes a browser engine, such as a general-purpose browser engine, or a native rendering component of a mobile operating system, to render a document written in a markup language, a style description language, and a scripting language. The terminal sends user-entered text to the server and displays response text received from the server. The user operates the terminal to input questions, requests, or complaints in natural language.

The server stores inquiry data, analysis result data, and verified response data in a structured manner in the storage device. The server uses a relational database management system such as a general-purpose relational database system or a document-oriented database system to maintain tables or collections that associate an inquiry identifier, raw text, timestamps, user identifiers, analysis results, prompt sentences, control information, response text, and emotion estimation values. The server uses index structures, such as B-tree indexes or hash indexes, to enable efficient retrieval of records by identifier or by time.

The server uses the analysis module to execute natural language processing on the inquiry data. The analysis module uses a natural language processing framework such as a general-purpose NLP library or a cloud-based NLP API. The server uses this module to perform tokenization by applying rule-based tokenizers or trained segmentation models, part-of-speech tagging by applying statistical taggers or neural taggers, important term extraction by applying term frequency-inverse document frequency weighting, attention-based scoring, or named-entity recognition models, and intent classification by applying a trained classifier. The server represents an inquiry as a sequence of tokens with associated linguistic tags and as a feature vector in a semantic space. The server uses this representation to generate analysis result data that includes at least an intent label, a list of important terms, and, optionally, named entities and syntactic dependency information.

The server uses a generative AI model that can be implemented as a transformer-based neural network. The server stores model parameters on a storage device and loads them into memory or an accelerator device during inference. The server uses a multi-layer neural network architecture that includes an embedding layer, a plurality of self-attention layers, feed-forward sublayers, and output projection layers. The server represents tokens as numerical vectors using a token embedding matrix and incorporates positional encodings. The server computes attention weights using scaled dot-product attention, where the server forms query, key, and value matrices and computes attention outputs by matrix multiplication and softmax operations. The server updates activations through non-linear functions such as rectified linear units or gated linear units.

The server uses the generative AI model interface module to supply a prompt sentence to the generative model. The server may host the generative model locally or communicate with a remote model service via an encrypted application programming interface. The server passes, as input, a tokenized representation of the prompt sentence, together with configuration parameters such as a maximum number of tokens to generate, a temperature parameter, a top-k or top-p sampling threshold, and a stop sequence specification. The server obtains, as output, a sequence of tokens representing response text data.

The server uses the prompt-construction module to generate a prompt sentence from the inquiry data and the analysis result data. The server includes in the prompt sentence a system-level instruction, a description of the user's inquiry, and control information. For example, the server can construct the following prompt sentence for a question about city hall opening hours:

“You are a public service support assistant.

A citizen asked: ‘Please tell me the opening hours of the city hall.’

Intent: ASK_OPENING_HOURS.

Answer clearly in one or two sentences.

Do not mention services of other organizations.

Generate only the final answer text.”

The server can also construct a prompt sentence for a question about a resident certificate as follows:

“You are a public service support assistant.

A citizen asked: ‘I want to know how to apply for a resident certificate.’

Intent: APPLICATION_PROCEDURE.

Explain the application steps in simple English using 3 to 5 bullet points.

Do not include any external commercial services.

Generate only the answer text.”

The server encodes control information such as domain specifications, style constraints, and length constraints into explicit textual instructions and, optionally, into structured tags within the prompt sentence. The server thereby causes the generative AI model to operate under more deterministic and bounded conditions, improving the stability of output and reducing unnecessary generation of irrelevant text.

The server uses the emotion-estimation module to infer a user's emotional state. The server performs this estimation by analyzing lexical features, such as sentiment-bearing words or phrases, syntactic patterns, and contextual signals from both the inquiry data and the generated response text data. The server uses a classifier model, which can be a neural network, a support vector machine, or a combined rule-based and statistical model. The server represents each text sample as a feature vector composed of word embeddings, sentiment lexicon scores, and syntactic counts. The server trains the emotion-estimation model using labeled training data specifying categories such as positive, negative, neutral, or urgency levels. During operation, the server computes a probability distribution over emotion classes and selects one or more dominant classes as the estimated emotional state.

The server uses the estimated emotional state to adjust the expression format of the prompt sentence or the response text data. For example, when the server detects that the user shows frustration, the server modifies the prompt sentence to instruct the generative AI model to respond in an especially polite and concise manner, to reassure the user, and to avoid technical jargon. When the server detects uncertainty or confusion, the server instructs the model to provide additional explanatory context and definitions. The server thus uses computationally derived emotional information as a control signal for text generation and formatting.

The server uses the verification-and-formatting module to validate and standardize the generated response text. The server checks for prohibited phrases by comparing tokens against a prohibited list stored in the storage device. The server evaluates length constraints by counting tokens or characters and truncates or regenerates segments if the generated text exceeds allowable limits. The server formats the response text into a structured representation, such as bullet lists or numbered steps, by inserting markers and adjusting punctuation. The server thereby enforces consistency and prevents the output of excessively long or malformed responses.

The server uses the history-management module to associate inquiry data, analysis result data, and verified response data. The server stores each set of related data under a unique session identifier. The server creates indexes over fields such as intent labels, important terms, and emotion categories. When the server receives new inquiry data, the server queries the history to locate similar past inquiries. The server uses similarity metrics based on vector distances between embedded representations of inquiries, using techniques such as cosine similarity in an embedding space produced by a sentence-embedding model. The server then reuses past control information, parameter settings, or portions of prior prompt sentences to construct a more optimized prompt for the new inquiry.

The server thereby improves processing efficiency. By performing tokenization, part-of-speech tagging, important term extraction, and intent classification before calling the generative AI model, the server reduces the input complexity to the generative model. The server removes extraneous or off-topic text from the prompt sentence and supplies focused context, which reduces the number of tokens that the model must process. As a result, the server reduces inference time and resource usage on the processor and any accelerator hardware. The server also decreases network bandwidth utilization when the generative model is hosted remotely, because the server transmits shorter prompt sentences and receives shorter, more controlled responses.

The server improves accuracy and consistency of responses. The server uses structured analysis result data and explicit control information to reduce variance in model behavior. The server limits the generative AI model to a specified domain and style, which reduces the occurrence of hallucinated or irrelevant content. The server uses emotion-aware control of the expression format to better match user expectations, which reduces the probability of follow-up inquiries requesting clarification. The server therefore lowers the number of total interactions necessary to resolve a single inquiry, further reducing computational and communication loads.

The server implements the generative AI model as a neural network trained by gradient-based optimization. The server trains the model on large text corpora using an objective function such as cross-entropy loss between predicted tokens and ground-truth tokens. The server performs backpropagation to compute gradients with respect to model weights and updates the weights using an optimization algorithm such as stochastic gradient descent, Adam, or another adaptive method. The server optionally applies regularization techniques such as dropout and weight decay and uses data augmentation techniques, such as paraphrasing or back-translation, to increase robustness. The server fine-tunes the model on domain-specific data related to public services, thereby adjusting the model's internal representations to the target domain.

The server trains the intent classification component and the emotion-estimation component separately or jointly. The server uses feature extraction pipelines that may include word embeddings, n-gram features, and attention-based pooling layers. The server trains these components on labeled examples, using loss functions such as cross-entropy over intent labels or emotion labels. The server monitors validation accuracy and adjusts hyperparameters such as learning rate, batch size, and network depth. The server thereby adapts the classifiers to accurately recognize user goals and emotional cues.

The server adopts non-conventional processing sequences that differ from manual human workflows. A human operator typically reads an inquiry and directly composes a response in free text. In contrast, the server decomposes the inquiry into machine-readable intermediate representations, automatically assigns structured labels, and then builds a prompt sentence that explicitly directs a generative AI model. The server uses explicit control information and emotion-derived parameters to manage the behavior of the model in a way that is not practicable for a human to perform consistently at scale. The server also uses historical data to dynamically modify prompt structure and model configuration, which constitutes a computer-centric optimization process that does not have an analogue in conventional human-only methods.

The server uses this architecture to provide technical improvements beyond simple automation of a manual task. The server reduces average compute cycles per resolved inquiry by shortening prompts and enforcing generation bounds. The server decreases memory footprint for cached prompts and responses by reducing unnecessary verbosity. The server improves cache locality for history lookups by using normalized and indexed intermediate representations. The server attenuates network traffic between the terminal and the server, and between the server and an external model host, by enforcing length constraints and reusing prompt templates derived from history. The server also improves overall system stability and predictability by transforming a black-box generative process into a controlled, multi-stage pipeline with verifiable intermediate states.

Alternative embodiments are possible. The server may integrate the generative AI model locally instead of using a remote model service. In such an embodiment, the server loads the neural network parameters into the main memory or GPU memory and performs inference using local compute resources. The server then eliminates external network latency for model calls but may allocate more local computation resources. In another embodiment, the server may use different types of generative models, such as sequence-to-sequence recurrent neural networks or encoder-decoder transformers, and may adjust the prompt sentence structure accordingly.

The server may change the analysis algorithms. For tokenization, the server may use a subword tokenizer such as byte-pair encoding. For important term extraction, the server may use graph-based ranking, clustering, or mutual information statistics. For intent classification, the server may use a hierarchical classifier that first determines a coarse category and then assigns a finer label. The server may also use ensemble methods that combine rule-based heuristics and learned models, thereby increasing robustness in noisy or low-resource conditions.

The server may incorporate additional control dimensions into the prompt sentence, such as a target reading level, a maximum number of bullet points, or a requirement to include or exclude numerical data. The server may structure the prompt sentence using explicit delimiters or tags to make the generative AI model more sensitive to boundaries between system instructions, user input, and context. The server can tune these patterns experimentally and store optimal patterns as templates in the history-management module. The terminal can vary in form. The terminal can be a handheld device, a desktop device, a kiosk, or an embedded device. The terminal can run a native application or a browser-based application. Regardless of form, the terminal maintains the role of input and output interface and executes only comparatively light processing, such as user interface rendering and simple validation, while the server performs heavy natural language processing and generative inference.

The user interacts with the system by providing natural language inquiries and reading generated responses. The user need not be aware of the internal processing steps or model architectures; however, the server uses these technical components to deliver responses with improved speed, consistency, and appropriateness. The server thus provides a concrete, technological implementation that uses a generative AI model and a prompt sentence, along with structured analysis and control, to enhance the efficiency and reliability of computer-based inquiry handling.

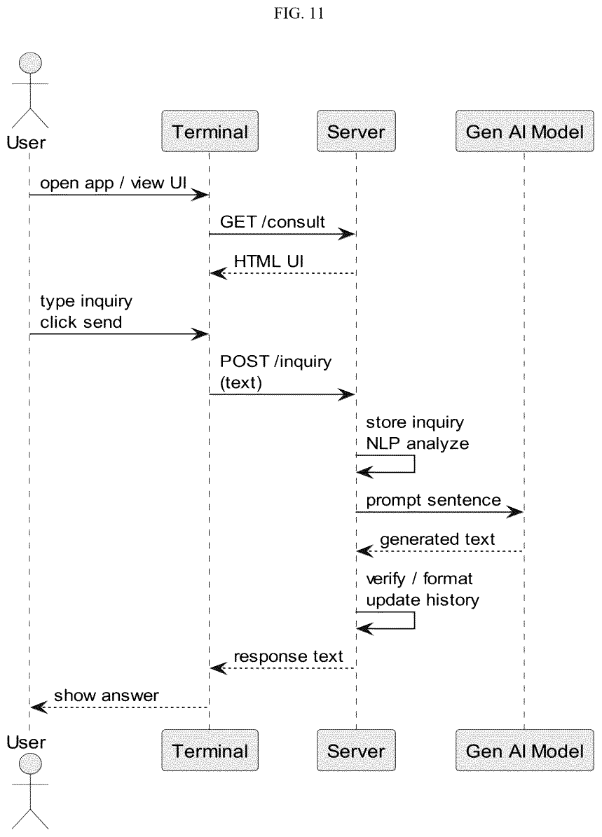

The following describes the processing flow using FIG. 11.

### Step 1

The user operates the terminal to start a web browser or a dedicated application and to open a consultation screen.

The terminal sends an HTTP GET request to the server as input.

The server generates, as output, an HTML document including a text input area, a send button, and client-side scripts, and returns this document to the terminal.

The terminal performs rendering processing on the HTML, CSS, and JavaScript to display the consultation interface on the display device.

### Step 2

The user inputs inquiry text, such as a question or request, into the text input area on the terminal.

The terminal takes the user's keystrokes and touch events as input and aggregates them into a text string representing the inquiry.

The terminal executes client-side script code to package this text string and optional metadata (for example, language code or session identifier) into a JSON object.

The terminal outputs an HTTP POST request containing the JSON object as the request body and transmits it to the server via the electronic communication network.

### Step 3

The server receives the HTTP POST request from the terminal through a web server component.

The server uses the application framework to parse the request headers and the JSON body as input.

The server executes data extraction operations to obtain an inquiry identifier (or generate one), the inquiry text, and user-related information from the JSON structure.

The server outputs a normalized internal representation of the inquiry data and writes this representation as a record into a database table, thereby producing a stored inquiry entry.

### Step 4

The server retrieves the stored inquiry text from the database or directly uses the inquiry text extracted from the request as input to the analysis module.

The server loads a natural language processing library into memory and passes the inquiry text to the library functions.

The server performs word segmentation processing by applying tokenization algorithms to split the text into tokens, and performs part-of-speech tagging by running a statistical or neural tagger over the token sequence.

The server then computes term importance scores using methods such as term frequency-inverse document frequency or attention-based weights, and extracts important terms and named entities from the token list.

The server feeds the token sequence and extracted features into an intent classification model to output an intent label, such as ASK_OPENING_HOURS or APPLICATION_PROCEDURE, and probability values.

The server aggregates tokens, part-of-speech tags, important terms, entities, and intent label into analysis result data and stores this structured data in the database as the output of this step.

### Step 5

The server reads the inquiry text and the corresponding analysis result data from the database as input to the prompt-construction module.

The server selects a domain-specific template and control parameters, including response style and maximum output length, based on the intent label and important terms.

The server concatenates fixed instruction phrases, the user's inquiry text, the intent label, and explicit control instructions into a single prompt sentence.

For example, the server constructs, as output, a prompt sentence such as:

“You are a public service support assistant.

A citizen asked: ‘Please tell me the opening hours of the city hall.’

Intent: ASK_OPENING_HOURS.

Answer clearly in one or two sentences.

Do not mention services of other organizations.

Generate only the final answer text.”

The server stores the generated prompt sentence as part of the consultation record.

### Step 6

The server calls a generative AI model using the prompt sentence and configuration parameters as input.

The server transforms the prompt sentence into token identifiers using a tokenizer, and then forwards these token identifiers, along with parameters such as temperature, top-k or top-p values, and maximum token count, to the generative AI model.

The server causes the generative AI model, which may be a transformer-based neural network, to perform matrix multiplications and attention computations on the token embeddings to predict the next token iteratively.

The server receives, as output, a sequence of generated token identifiers, converts these identifiers back into text characters or words, and obtains response text data representing a candidate answer.

### Step 7

The server provides the response text data as input to the verification-and-formatting module. The server scans the response text data for prohibited terms, checks for compliance with length constraints by counting tokens or characters, and evaluates basic structural rules (for example, presence of required bullet markers or sentence boundaries).

The server executes string processing operations to remove or replace disallowed expressions, truncate overlong text, and adjust layout to match the specified response style.

The server outputs verified response data that satisfies predefined content and format policies and stores this verified data in the database.

### Step 8

The server uses the inquiry data and the response text data as input to the emotion-estimation module.

The server extracts lexical features such as sentiment words, calculates sentiment scores, and constructs feature vectors including word embeddings, sentiment lexicon values, and, optionally, punctuation statistics.

The server feeds the feature vectors into an emotion classifier model to compute a probability distribution over emotion categories such as positive, negative, neutral, or urgent.

The server outputs an estimated emotional state label and a confidence score and stores these as part of the consultation record.

### Step 9

The server uses the estimated emotional state and the original prompt sentence or response text as input to a tone-adjustment function.

The server applies rule-based transformations or additional generative passes to modify the expression format, for example by inserting more polite phrases, simplifying vocabulary, or adding clarifying sentences when confusion is detected.

The server outputs an adjusted prompt sentence for future use or an adjusted response text for immediate use, depending on system configuration, and updates the database with the adjusted version.

### Step 10

The server prepares a response payload using the verified and optionally emotion-adjusted response text as input.

The server constructs a structured object that includes at least a consultation identifier and the final answer text, and serializes this object into a JSON string.

The server sets appropriate HTTP headers and status code and sends an HTTP response containing the JSON string to the terminal as output.

### Step 11

The terminal receives the HTTP response from the server through its networking stack.

The terminal uses a scripting engine or native code to parse the JSON payload as input and extracts the final answer text and any associated metadata.

The terminal updates the display by rendering the answer text in the output display area, optionally formatting it into chat bubbles or bullet lists.

The terminal outputs a visually presented response that the user can read on the display device.

### Step 12

The user views the displayed answer on the terminal and evaluates whether the answer resolves the inquiry.

If the user has a follow-up question, the user provides additional input text to the terminal based on the previously displayed answer.

The terminal treats the follow-up inquiry as new input, associates it with a new or existing consultation identifier, and sends another HTTP POST request to the server.

The server receives this new inquiry, stores it, and reuses the history and analysis mechanisms from previous steps to process the follow-up inquiry, thereby outputting refined responses in subsequent iterations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems that utilize a generative AI model for natural language interaction typically treat user inquiries as free-form text and forward such text directly to the generative AI model. As a result, the behavior of the system is highly dependent on the internal heuristics of the model and is not systematically constrained or optimized at the system level. For example, in an in-facility guidance scenario such as a commercial facility or service facility, conventional systems often fail to reliably extract the user's actual intention, do not consistently distinguish between different inquiry types such as popularity, location, and sales conditions, and do not consistently integrate structured facility data with generated text. This can lead to unstable response quality, hallucinated facility information, and missing or incorrect positional or floor information in the final guidance presented to the user.

In addition, existing computer systems that call a generative AI model are often designed as thin wrappers around the model, without implementing an intermediate layer that classifies inquiries, constructs a type-specific prompt sentence, and enforces consistency between model outputs and a trusted information storage medium. Without such an intermediate processing layer, the computer cannot fully leverage its own structured data (such as facility information, item information, or guidance information stored in a database) to guide the generative AI model toward more accurate and contextually appropriate responses. This limitation manifests as an inefficiency of the overall information processing pipeline, in which the generative AI model must infer context that the computer already stores but does not systematically provide.

Furthermore, conventional systems do not provide a robust mechanism for generating display-ready information that specifically includes position information or floor information of a presentation target in accordance with a classified inquiry type. As a consequence, user terminals often receive unstructured text that must be post-processed in an ad hoc manner, resulting in increased complexity on the client side and inconsistent user experience across different terminals.

Accordingly, there is a need for an improved computer-implemented system that, at the processor level, (i) normalizes and analyzes inquiry text to determine an inquiry type, (ii) selects and constructs a prompt sentence in a type-dependent manner, (iii) integrates structured facility information, item information, or guidance information into the prompt sentence prior to calling a generative AI model, (iv) verifies and, if necessary, corrects the output from the generative AI model using the structured information, and (v) generates structured display information including position information or floor information suitable for presentation on a user terminal. Such a system would improve the technical functioning of the computer by structuring and constraining the interaction with the generative AI model, reducing erroneous outputs, and optimizing the end-to-end information processing flow from user input to user display.

The specific processing by the specific processing unit 290 of the data processing device 12 in Application Example 1 is realized by the following means.

The present invention provides a server comprising a processor and a memory storing instructions that, when executed by the processor, cause the processor to receive inquiry information from a user terminal via a communication network; normalize character information included in the inquiry information and analyze a character string of the inquiry information to classify an intention of the inquiry and determine an inquiry type; select, in accordance with the inquiry type, at least one explanation template from among a plurality of explanation templates stored in a storage medium, and construct a prompt sentence for a generative AI model based on the inquiry information and the selected explanation template; acquire, from an information storage medium, facility information, item information, or guidance information associated with the inquiry type, and correct the prompt sentence by incorporating the facility information, the item information, or the guidance information into the prompt sentence; input the corrected prompt sentence to the generative AI model and perform natural language processing to obtain response information or guidance information corresponding to the inquiry information; compare the obtained response information or guidance information with the facility information, the item information, or the guidance information acquired from the information storage medium, and, when an inconsistency is present between them, correct the response information or the guidance information based on information acquired from the information storage medium; generate display information including at least one of position information or floor information of a presentation target based on contents of the corrected response information or the corrected guidance information and based on the inquiry type; and transmit the display information to the user terminal via the communication network so that the display information is presented to a user on the user terminal. This enables the computer system to more efficiently and reliably control interaction with the generative AI model, to constrain the model output using structured facility-side data, to reduce erroneous or inconsistent guidance, and to deliver structured, location-specific display information to the user terminal, thereby improving the overall technical performance of the information processing pipeline.

The term “system” refers to a combination of one or more hardware devices and one or more software components that cooperate to execute information processing functions described in the present specification and claims.

The term “processor” refers to a hardware computation unit, such as a central processing unit or other programmable processing circuitry, that executes instructions to perform the functions described herein.

The term “memory” refers to a hardware storage device, such as a volatile memory or a non-volatile memory, that stores instructions and data for execution and use by the processor.

The term “user terminal” refers to an information processing device operated by a user, such as a portable terminal, a stationary terminal, or a similar computing apparatus, that transmits inquiry information to the server and receives display information from the server.

The term “communication network” refers to a communication infrastructure, including at least one of a wired network or a wireless network, that enables data transmission between the server and the user terminal.

The term “inquiry information” refers to electronic data representing a request, question, or other input provided by a user via the user terminal and transmitted to the server for processing.

The term “character information” refers to textual data composed of symbols, letters, numerals, or other characters that form at least part of the inquiry information.

The term “normalize” refers to processing that converts character information into a standardized format, including at least one of unifying encoding, trimming unnecessary characters, or harmonizing character representations to facilitate consistent analysis.

The term “character string analysis” refers to processing that examines a sequence of characters included in the inquiry information to detect patterns, keywords, or structures used to infer the intention of the inquiry.

The term “intention of the inquiry” refers to a semantic objective or purpose expressed by the user in the inquiry information, such as requesting popularity information, requesting location information, or requesting sales-condition information.

The term “inquiry type” refers to a classification label assigned to the inquiry information based on the inferred intention of the inquiry, such as a popularity-related type, a location-related type, or a sales-condition-related type.

The term “storage medium” refers to a physical recording medium, such as a semiconductor memory, a magnetic storage device, or an optical storage device, that stores data including explanation templates and other information used by the processor.

The term “explanation template” refers to a predefined text pattern or structure that is stored in the storage medium and is used as a basis for constructing a prompt sentence for a generative AI model in accordance with the inquiry type.

The term “prompt sentence” refers to structured text generated by the processor using one or more explanation templates and the inquiry information, and provided as input to a generative AI model to control or guide the behavior of the model.

The term “generative AI model” refers to a trained information processing model, such as a machine-learning-based language model, that receives a prompt sentence as input and generates response information or guidance information in natural language.

The term “information storage medium” refers to a storage device, which may be the same as or different from the storage medium, that stores structured data including facility information, item information, and guidance information used to support or correct operations of the generative AI model.

The term “facility information” refers to structured data describing an environment in which the user is located or to which the inquiry relates, including at least one of zone information, floor information, or position information within a facility.

The term “item information” refers to structured data describing a commodity, a service, or another object of interest, including at least one of an identifier, a category, an attribute, a popularity ranking, or a location within a facility.

The term “guidance information” refers to structured data representing instructions, recommendations, or navigational details used to guide the user, including at least one of directional information, usage instructions, or promotion details.

The term “correct the prompt sentence” refers to modifying the initially constructed prompt sentence by incorporating facility information, item information, or guidance information, thereby refining the content of the prompt sentence prior to input to the generative AI model.

The term “response information” refers to text or other data generated by the generative AI model in response to the prompt sentence, intended to answer or address the inquiry information.

The term “guidance information (generated)” refers to text or other data generated by the generative AI model that provides instructions, recommendations, or directions to the user based on the prompt sentence and the inquiry information.

The term “display information” refers to structured output data generated by the processor that includes at least one of position information or floor information of a presentation target, and that is formatted for presentation on a display unit of the user terminal.

The term “position information” refers to data indicating a spatial location of a presentation target within a facility, including at least one of an area, a zone, a section, or a coordinate.

The term “floor information” refers to data indicating a level or story within a multi-level facility at which a presentation target is located.

The term “presentation target” refers to an object, such as an item, a facility zone, or a service counter, to which the response information or guidance information relates and for which position information or floor information is provided.

The term “inconsistency” refers to a discrepancy or contradiction between the response information or guidance information generated by the generative AI model and the facility information, item information, or guidance information stored in the information storage medium.

The term “correct the response information or the guidance information” refers to modifying at least part of the model-generated output so that the content is brought into conformity with the facility information, item information, or guidance information stored in the information storage medium.

The term “user” refers to a human operator or other entity that uses the user terminal to provide inquiry information and to receive display information from the system.

In one embodiment, a server, a terminal, and a user cooperate via a communication network to implement the claimed system. The server includes a processor, a memory, a non-transitory storage medium, a network interface, and an interface to one or more information storage media such as a database system. The terminal includes a processor, a memory, a display unit, an input unit such as a touchscreen, and a communication interface. The user operates the terminal to input inquiry information and to view display information that is generated and transmitted by the server.

The server executes an information processing program stored in the memory. The server uses a general-purpose operating system such as a UNIX-like operating system, and application software implemented, for example, in a programming language such as Python. The server runs a web application framework, for example a framework of the Flask type, and communicates with a generative AI model provided as a remote service via an application programming interface using an HTTP-based protocol. The generative AI model is of the large-scale neural network type, for example a transformer-based language model similar to a GPT-type model, which is trained in advance on text data and is capable of generating natural language responses based on an input prompt sentence.

The terminal executes a client-side program such as a web browser application or a native application. The terminal uses the browser's scripting engine, for example a JavaScript engine, or a native language runtime, for example a runtime of the Swift type or of the Kotlin type, to handle user input and to render display information. The terminal communicates with the server using standard communication protocols such as HTTPS over a wireless or wired network.

The server stores, in the information storage medium, structured facility information, structured item information, and structured guidance information. The server stores these data in relational tables or key-value records. For example, the server stores facility information including fields such as facility identifier, floor identifier, zone identifier, and coordinate information. The server stores item information including fields such as item identifier, category, popularity rank, and associated facility location. The server stores guidance information including fields such as route description, directional arrows, and textual captions. The server also stores, in the storage medium, a plurality of explanation templates. Each explanation template is a text pattern that includes placeholders for user inquiry text, facility information, item information, and guidance information, and is associated with one or more inquiry types.

The server analyzes inquiry information received from the terminal by applying character-level and token-level processing. The server normalizes character information by converting the text to a canonical encoding such as UTF-8, unifying full-width and half-width characters if necessary, removing invisible control characters, and standardizing whitespace. The server then performs character string analysis. The server generates a lowercased copy of the inquiry text and performs substring search for keywords mapped to particular inquiry types. In some embodiments, the server uses a statistical classifier stored in the memory, such as a logistic regression classifier or a lightweight neural network classifier, that operates on bag-of-words features, n-gram features, or encoded token embeddings, to determine an inquiry type label. The server outputs one or more inquiry types, such as a popularity-related type, a location-related type, or a sales-condition-related type.

The server improves computer technology by adding a deterministic classification and template selection layer between the raw inquiry and the generative AI model. The server prevents the generative AI model from having to infer basic context that is already available in structured form. As a result, the server reduces the number of tokens in the prompt sentence, decreases the search space of potential completions, and leads to faster inference and reduced computational load in the generative AI model's transformer layers. This reduction in token processing directly reduces the number of matrix multiplications in the attention mechanism and improves processing throughput on the underlying hardware accelerators.

The server constructs a prompt sentence based on the determined inquiry type and the selected explanation template. The server performs data processing operations such as template substitution and concatenation. The server replaces placeholders in the explanation template with the normalized inquiry text and with formatted strings representing facility information, item information, and guidance information fetched from the information storage medium. The server uses a strict data schema for facility-side data, and the server converts database fields into short, unambiguous textual fragments. By constraining the structure of the prompt sentence, the server ensures that the generative AI model receives consistent context, which reduces variance in the generated output and increases accuracy of positional and floor-related guidance.

In one example, the server constructs a prompt sentence for a popularity-related inquiry as follows:

You are an in-store assistant for a retail facility.

Use the provided facility data and item data if available.

Customer question: “What is the most popular product in this store right now?”

Store data: Most popular item: Latest smartphone model, Location: 3rd floor, electronics zone.

Generate a concise, friendly answer in one or two sentences for the customer.

In another example, the server constructs a prompt sentence for a location and promotion-related inquiry as follows:

You are a store assistant.

The customer is asking about both product location and promotions.

Customer question: “Where can I find children's shoes on sale today?”

Store data: Category: children's shoes, Floor: 2nd floor, Zone: kids section, Promotion: discount items available.

Use the store data. If you do not have more details, answer in general terms.

Generate a short, friendly answer that can be shown on a mobile terminal.

The server sends the constructed prompt sentence to the generative AI model via the communication network. The server formats the request into a data structure specifying the model identifier, the prompt sentence, and generation parameters such as a token limit and a randomness parameter. The generative AI model, operating on separate computing hardware, uses a neural network architecture of the transformer type. The model represents the prompt sentence as a sequence of tokens, applies an embedding layer to map tokens to high-dimensional vectors, and propagates these vectors through a stack of self-attention blocks and feed-forward layers. During training of such a model, a loss function such as cross-entropy loss is minimized by adjusting weight parameters with an optimization algorithm such as stochastic gradient descent or Adam, using large-scale text corpora. Although this training is performed separately, the server exploits the trained model by carefully shaping inputs through the prompt sentence.

The server distinguishes itself from simple automation of human work by using non-conventional, computer-specific rules in constructing and post-processing prompts. For example, the server restricts the generative AI model to operate under a narrow, structured context drawn from the facility database, and the server enforces integrity constraints by comparing generated outputs against database records. A human staff member typically would not perform rapid consistency checks against a large digital database for every question. The server, however, performs such checks automatically by executing comparison algorithms on in-memory data structures, which results in a unique digital control loop that is specific to the computer architecture and database layout.

The server receives the output text (response information or generated guidance information) from the generative AI model. The server then executes a verification step using structured facility information, item information, and stored guidance information. The server parses the generated text to identify floor identifiers, zone names, and item descriptions by applying pattern matching, regular expressions, or a lightweight entity recognition model. The server compares the recognized entities with corresponding fields stored in the information storage medium. If the server detects an inconsistency, such as a floor identifier that does not exist in the facility table or a zone name not associated with the referenced item category, the server corrects the generated response. The server can override conflicting portions of the generated text with trusted values from the facility database. This correction process reduces hallucinated details and significantly lowers the probability that the system will present nonexistent locations or incorrect floor information.

The server generates structured display information intended for the terminal. The server converts the corrected response into data that explicitly contains position information and floor information of a presentation target, for example an item or a zone. The server may produce a structure that includes a textual description, a floor label, a zone identifier, and coordinates relative to a map used by the terminal. Because the server has enforced alignment with the database, the server can guarantee that the floor identifier and zone identifier included in the display information correspond to actual records. This enables the terminal to perform secondary processing such as rendering arrows on a map or filtering for accessibility routes without additional validation logic.

The server improves data management and communication efficiency by separating high-entropy natural language content from low-entropy structured identifiers. The server transmits compact identifiers and floor codes embedded in or alongside short natural language descriptions, rather than sending long, ambiguous text that would require parsing on the client side. The server thereby reduces the bandwidth required per inquiry and simplifies terminal-side logic. In high-load environments where many user terminals operate simultaneously, this reduction in data size and processing overhead contributes directly to improved throughput and reduced latency for the overall system.

The terminal presents display information to the user in a structured format. The terminal maps the received floor identifier and position information to graphical elements such as floor maps, directional icons, and textual labels. The terminal uses the display hardware efficiently by highlighting the relevant section of the floor map and by showing the generated text next to it. Because the server has already normalized and corrected the guidance data, the terminal does not need to run complex natural language analysis or database consistency checks. This division of labor results in lower computational requirements on the terminal, extending battery life and improving responsiveness.

The server achieves technical benefits beyond generic human-task automation by tailoring the entire computational pipeline for machine-model cooperation. The server pre-structures the context before invoking the generative AI model, and the server post-filters and corrects model output based on strict constraints derived from the facility database. By introducing this two-way constraint mechanism, the server significantly reduces the rate of erroneous outputs and lowers the necessary number of repeated model calls caused by user dissatisfaction. Quantitatively, the server reduces average response generation time because fewer follow-up clarifications are needed, and token-level processing in the generative AI model is reduced due to shorter, more focused prompt sentences.

In another embodiment, the server uses a hybrid rule-based and neural method for inquiry type determination. The server first applies a rule-based classifier that uses predefined keyword lists linked to inquiry types. If the rule-based classifier produces an ambiguous result, the server applies a small auxiliary neural network model locally. This auxiliary model uses a compact word embedding matrix and a shallow feed-forward architecture to produce an inquiry type probability vector. This hybrid method optimizes computation by applying the neural network only when necessary. As a result, the server reduces average CPU and memory usage while maintaining high classification accuracy, which is a direct improvement of computer resource utilization.

In a further embodiment, the server maintains a cache of recently used explanation templates and frequently requested facility or item information in memory. The server uses a replacement policy such as least-recently-used to manage the cache. When the server receives an inquiry relating to a popular category or a frequently accessed facility zone, the server can build the prompt sentence using cached template expansions without querying the database repeatedly. This caching strategy reduces disk I/O and database query latency and improves overall throughput. Importantly, the server can pre-compose segments of prompt sentences for common scenarios, thus further reducing the computational cost of string operations and tokenization.

In another embodiment, the server updates or refines the explanation templates and correction rules based on logs of past interactions. The server stores, in a log storage, pairs of inquiry information, prompt sentences, generated responses, and corrected display information. The server periodically analyzes this log using offline batch processing to identify patterns where responses often required correction. The server then updates rule sets such as forbidden phrases, preferred wording, or mappings from vague terms to precise facility labels. This iterative refinement improves the accuracy and consistency of future responses without needing to retrain the large generative AI model itself, thereby decoupling the improvement cycle of system-level behavior from the heavy training process of the model.

In yet another embodiment, the server and the terminal cooperate to support multimodal usage. The terminal converts voice input from the user into text by using an automatic speech recognition engine running locally or on a separate server. The terminal sends the recognized text to the server as inquiry information. The server processes the text in the same manner described above. This arrangement allows the system to be deployed in noisy environments or hands-busy scenarios while maintaining the same structured pipeline of normalization, prompt sentence construction, model invocation, correction, and display generation.

The described embodiments focus on the server's internal technical processing, including specific data structures, normalization strategies, classification algorithms, prompt sentence composition rules, consistency-checking logic, and caching mechanisms. By tightly integrating these components with a transformer-based generative AI model, the system achieves technical effects such as improved response accuracy, reduced computational load on both server and model infrastructure, reduced communication bandwidth, enhanced robustness against data inconsistencies, and improved user-perceived latency. The resulting improvement lies in the architecture and operation of the computer system itself and does not merely represent automation of a human clerk's task, but rather an optimized, model-aware information processing pipeline that is specifically adapted to the properties and limitations of generative AI models.

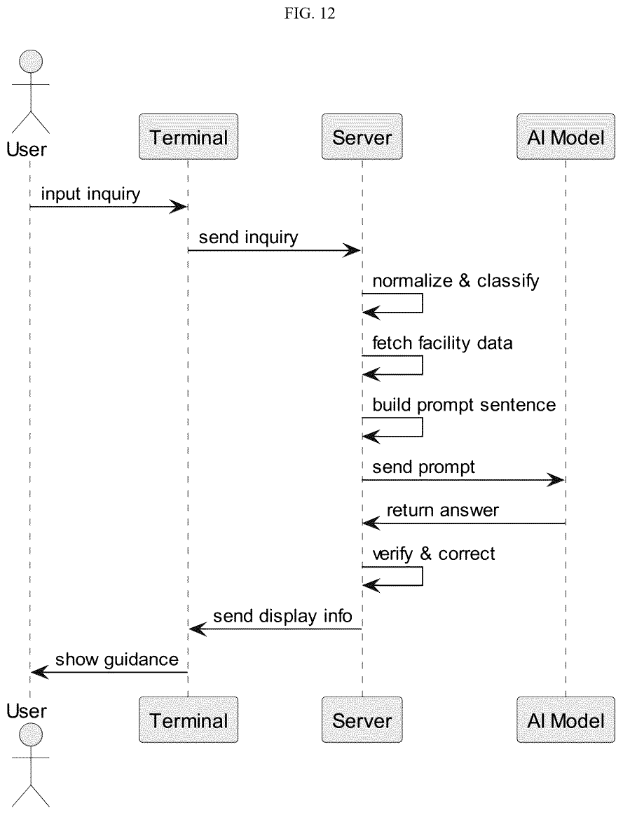

The following describes the processing flow using FIG. 12.

### Step 1

The user operates the terminal to input an inquiry. The user touches a text input field on the terminal display and enters an inquiry sentence such as “Where can I find the latest smartphones?” using a software keyboard or voice-to-text function. The terminal receives this inquiry as a character string. The terminal sets the inquiry string as input to a local data structure (for example, an internal variable of a client application). The terminal then generates a request object that includes the inquiry string and, optionally, context information such as language, facility identifier, and user location within the facility. The terminal outputs this request object to the communication stack in preparation for transmission to the server.

### Step 2

The terminal sends the inquiry information to the server. The terminal takes the request object as input and serializes it into a message format such as a JSON-formatted payload. The terminal uses a network library to encapsulate the payload into an HTTP request addressed to an application programming interface endpoint of the server. The terminal applies encryption according to a transport layer security protocol and transmits the encrypted packets via a communication network. The output of this step is an HTTP request containing the inquiry information that is delivered to the server's network interface.

### Step 3

The server receives and parses the inquiry information. The server takes the HTTP request as input through its network interface and passes it to a web application framework. The server extracts the payload from the network-layer packets and performs JSON parsing to recover the inquiry string and any associated metadata. The server stores the parsed content in memory as internal variables such as an inquiry text variable and a facility identifier variable. The server logs the raw inquiry for monitoring. The output of this step is a set of normalized internal variables representing the inquiry information.

### Step 4

The server normalizes the inquiry text. The server takes the inquiry text variable as input and applies character-level processing. The server converts the text to a standard encoding such as UTF-8, removes control characters, trims leading and trailing whitespace, and replaces multiple spaces with a single space. The server optionally converts the text to a standardized case form, such as lowercasing a copy for analysis while preserving the original form for later display. The server uses string operations and predefined normalization rules to perform these transformations. The output of this step is a cleaned inquiry text and a lowercased analysis text, both stored in memory.

### Step 5

The server determines an inquiry type. The server takes the normalized analysis text as input and performs character string analysis. The server searches for presence of keywords or patterns associated with predefined categories, for example “popular” for popularity-related, “where” or “find” for location-related, and “sale” or “discount” for sales-condition-related. The server executes conditional branching logic and may also feed the analysis text into a local classifier that uses features such as token counts or word embeddings. Based on these computations, the server outputs one or more inquiry type labels, such as “location” or a combination like “location +promotion,” and stores them as an inquiry type variable in memory.

### Step 6

The server selects an explanation template. The server takes the inquiry type variable as input and queries a template storage structure, such as a table in a database or a template registry in memory, where each explanation template is associated with one or more inquiry types. The server performs a lookup operation to obtain a template that matches the determined inquiry type. If more than one template matches, the server applies selection rules, such as priority rankings or context-specific conditions. The server outputs a selected explanation template in the form of a text pattern containing placeholders for inquiry text and facility-side data.

### Step 7

The server acquires structured facility and item data. The server takes the inquiry type and any facility identifier or item category from the parsed request as input. The server constructs a query against an information storage medium such as a relational database. For example, the server executes a search for records in tables that store floor information, zone identifiers, or item popularity rankings. The server filters the results based on criteria related to the inquiry type, such as limiting to a specific category or selecting only the highest-ranked item for a popularity request. The server converts the retrieved records into an internal structured representation, such as key-value pairs or objects holding floor, zone, and item attributes. The output of this step is a set of facility information, item information, or guidance information linked to the inquiry.

### Step 8

The server constructs a prompt sentence. The server takes as input the selected explanation template, the normalized inquiry text, and the structured facility-side data. The server performs text substitution by replacing template placeholders with the actual inquiry sentence and with formatted snippets summarizing the retrieved facility or item information. For example, the server concatenates strings to form segments such as “Floor: 3rd floor, Zone: electronics section, Item: latest smartphone model.” The server assembles these segments into a coherent prompt sentence that instructs the generative AI model how to respond. The output of this step is a complete prompt sentence ready for submission to the generative AI model.

### Step 9

The server sends the prompt sentence to the generative AI model. The server takes the constructed prompt sentence as input and creates a model request object including parameters such as a model identifier, a maximum token count, and a temperature value controlling randomness. The server serializes this request into a format expected by the generative AI model's application programming interface and transmits it over a secure communication channel. The server's processor marshals the data into network frames and delegates them to the underlying network stack. The output of this step is a remote inference request received by the generative AI model.

### Step 10

The server receives and extracts the model output. The server takes the generative AI model's response as input, delivered over the communication interface. The server parses the response structure to obtain the generated text segment designated as response information or generated guidance information. The server removes protocol-specific overhead, decodes the text content if necessary, and stores the text in memory. The output of this step is a raw model-generated response string representing the model's natural language answer to the prompt sentence.

### Step 11

The server verifies consistency of the generated response. The server takes the raw model-generated response string and the structured facility-side data as input. The server applies parsing logic to the response string to detect mentions of floors, zones, item categories, or item names. The server uses pattern-matching algorithms or small entity-recognition routines to extract these elements. The server then compares the extracted elements with corresponding fields in the facility and item information retrieved earlier. If the server identifies a mismatch, such as a non-existent floor or a zone that does not match the item category, the server flags the inconsistency. The output of this step is a verification result and a list of portions in the response that require correction, if any.

### Step 12

The server corrects the generated response based on structured data. The server takes the verification result, the model-generated response string, and the structured facility-side data as input. When inconsistencies are detected, the server replaces the conflicting parts of the response string with correct values sourced from the facility information, such as valid floor identifiers or zone names. The server may also adjust phrasing to maintain grammatical coherence after replacement. The server thereby produces a corrected response text that aligns with the stored facility and item information. The output of this step is a finalized, corrected response string that is suitable for presentation to the user.

### Step 13

The server generates display information for the terminal. The server takes the corrected response string and the structured facility-side data as input. The server composes display information that includes at least one of position information and floor information of a presentation target. The server arranges the data into a structured representation, separating natural language text from identifiers such as floor codes, zone codes, and item identifiers. The server may also compute additional elements, such as relative positions on a facility map, based on stored coordinates. The output of this step is a display information object containing both human-readable guidance and machine-usable location data.

### Step 14

The server sends the display information to the terminal. The server takes the display information object as input and encapsulates it into a response payload. The server serializes the payload, applies necessary encoding, and embeds it into an HTTP response addressed to the terminal. The server transmits the response over the communication network, using the network interface to send packets and handle transmission control. The output of this step is a response message containing structured display information delivered to the terminal.

### Step 15

The terminal receives and interprets the display information. The terminal takes the server's response message as input and invokes its communication library to decode the payload. The terminal parses the structured display information to obtain the corrected response text, the floor identifier, the zone identifier, and any coordinate data. The terminal stores these components in local memory as variables or objects ready for user interface rendering. The output of this step is an internal representation of the display information within the terminal.

### Step 16

The terminal presents the guidance to the user. The terminal takes the internal representation of the display information as input and updates user interface elements on the display unit. The terminal sets a text area to show the corrected response string, for example “You can find the latest smartphones on the 3rd floor in the electronics section, near the central escalator.” The terminal uses the floor and zone identifiers to highlight the appropriate region on a map view or to generate direction arrows. The terminal renders these visual elements using its graphics subsystem and outputs the drawn content to the display hardware. The user then visually perceives the result and can act on the presented guidance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information provision systems for public services and public facilities typically rely on manually designed intent classifiers, rule-based dialogue flows, or static query templates to process user inquiries. Such systems suffer from several technical limitations. First, they exhibit low robustness to diverse natural-language expressions, dialects, and ungrammatical input, which results in frequent intent misclassification and query failure. Second, they generally require an engineer to predefine fixed mappings from recognized intents to database query templates, so that any change in the underlying data schema or any addition of a new service category forces a corresponding code change and redeployment. This tight coupling between natural-language understanding logic and database access logic leads to high maintenance costs and reduced system scalability. Moreover, existing architectures often treat natural-language understanding and database retrieval as separate components glued together by ad hoc middleware. Because the intermediate representation between the natural-language component and the database component is not standardized or machine-readable, the system cannot reliably or automatically construct a structured query. As a result, error handling, logging, and monitoring are complicated, and performance optimization, such as query caching and query refactoring, is difficult to automate.

Furthermore, many known systems generate responses to users using handcrafted templates or simple string concatenation, which cannot flexibly adapt to varied user preferences, contextual information, or the richness of the retrieved data. This leads to responses that are either too rigid or too verbose, and the overall user experience suffers from reduced clarity and relevance. From a computing-technology standpoint, the processing pipeline is fragmented, and computing resources are not efficiently orchestrated across natural-language analysis, structured data access, and response generation.

Accordingly, there is a need for an improved computer-implemented system that (i) uses a generative AI model in a structured way to analyze user inquiries, (ii) obtains machine-readable analysis results suitable for programmatic generation of structured database queries, and (iii) uses the same or another generative AI model to synthesize a natural-language response from both the original inquiry and the retrieved data. There is also a need to technically integrate these stages in a unified processing flow that can dynamically adapt to changes in database schema and data content without extensive manual reconfiguration, thereby improving robustness, extensibility, and efficiency of the underlying computing system.

The specific processing by the specific processing unit 290 of the data processing device 12 in Example 2 is realized by the following means.

The present invention provides a server comprising a processor configured to (i) receive, via a communication network, an information request expressed in natural language from a user terminal and extract inquiry information from the information request, (ii) generate a first prompt sentence using the inquiry information as input and input the first prompt sentence to a generative AI model in order to obtain, by natural language processing, analysis result information including at least an intent, a target concept, and a condition related to the inquiry information, the analysis result information being output in a machine-readable format, (iii) dynamically generate, based on the analysis result information, a query request in a structured query language and transmit the query request to an information storage device configured to store an information set including attribute information regarding public services or public facilities, thereby acquiring target data related to the information request from the information storage device, (iv) generate a second prompt sentence using the target data and the inquiry information as input and input the second prompt sentence to a generative AI model in order to generate response information expressed in natural language in a format and expression that are easy for a user to understand, and (v) transmit the response information to the user terminal via the communication network so that the response information is output to the user by display processing at the user terminal. This enables a technically integrated processing pipeline in which natural-language user inquiries are robustly interpreted into a machine-readable representation, automatically translated into optimized structured database queries, and converted back into adaptive natural-language responses, thereby improving the accuracy, maintainability, and scalability of computer-based public information services.

The term “system” refers to a combination of one or more hardware devices and software components that cooperate to execute information processing operations described in the claims.

The term “processor” refers to one or more processing units, such as a central processing unit, a graphics processing unit, or any other programmable computation circuit, configured to execute instructions for performing the claimed operations.

The term “communication network” refers to any wired or wireless data communication infrastructure, including a local area network, a wide area network, or a global network, through which data signals are exchanged between the server and user terminals.

The term “user terminal” refers to any information processing apparatus operated by a user, such as a portable terminal, a stationary terminal, or a graphical user interface device, capable of transmitting and receiving data via the communication network.

The term “information request” refers to a sequence of natural-language expressions input by a user for requesting information regarding a subject matter, including but not limited to public services or public facilities.

The term “natural language” refers to a human language used in ordinary communication, including various vocabularies, grammars, and linguistic variations.

The term “inquiry information” refers to data representing at least a portion of the content of the information request, extracted for subsequent analysis or processing by the processor.

The term “prompt sentence” refers to a text or text-like data structure provided as input to a generative AI model, the text including instructions, constraints, or contextual information for controlling output of the generative AI model.

The term “generative AI model” refers to a machine-learned computation model configured to receive an input sequence and generate an output sequence, including at least a large-scale neural network that performs natural language processing based on training data.

The term “natural language processing” refers to an information processing technique by which a computation model or software analyzes, interprets, or generates expressions in a natural language.

The term “analysis result information” refers to data output by the generative AI model that represents interpretation of the inquiry information, including at least an intent, a target concept, and one or more conditions relevant to subsequent data retrieval.

The term “intent” refers to a representation of a purpose or objective underlying the information request, expressed in a machine-readable manner.

The term “target concept” refers to a category, entity, or object type identified from the inquiry information as a main subject to be retrieved from an information source.

The term “condition” refers to one or more constraints, parameters, or contextual requirements derived from the inquiry information, used for limiting or specifying a data retrieval operation.

The term “machine-readable format” refers to a data representation, such as a structured text, a markup, or a serialized data structure, that can be programmatically parsed and processed by software without human interpretation.

The term “information storage device” refers to one or more storage media and associated control circuitry configured to store and provide access to data, including databases, storage servers, or storage subsystems.

The term “information source” refers to any logical or physical data repository from which the processor acquires data related to the information request.

The term “information set” refers to a collection of records, entries, or data items stored in the information storage device and managed as a logical group for retrieval processing.

The term “attribute information” refers to data items representing properties, characteristics, or parameters of an entity, such as name, address, opening hours, or type.

The term “public services” refers to services provided by a public organization, administrative body, or similar entity for use by general citizens.

The term “public facilities” refers to physical or virtual facilities provided by a public organization, including but not limited to parks, libraries, offices, and service counters.

The term “structured query language” refers to a formal language used for defining, manipulating, and querying structured data in an information storage device, including but not limited to a relational database query language.

The term “query request” refers to a data structure or message specifying a retrieval operation, update operation, or similar operation to be executed against the information storage device.

The term “target data” refers to data items retrieved from the information storage device that satisfy at least a portion of the conditions derived from the analysis result information.

The term “response information” refers to natural-language content generated by the generative AI model for presentation to the user, the content being based on at least the inquiry information and the target data.

The term “display processing” refers to one or more operations executed by the user terminal to visually or otherwise perceptibly present the response information to the user.

In one embodiment, a server includes a processor, a memory, a storage device, and a network interface, and cooperates with one or more terminals operated by users. The server executes an operating system, such as a general-purpose server operating system, and application software implemented, for example, using a server-side framework. The server further communicates with one or more information storage devices, such as relational database systems, and with one or more generative AI models deployed either locally or on a remote computation platform.

The server stores, in the storage device, a set of program modules including at least a communication control module, a prompt generation module, an analysis interpretation module, a query construction module, a response generation module, and a logging and monitoring module. The memory stores these modules during execution so that the processor can perform the information processing described below.

The terminal executes a browser application or a dedicated client application on computation hardware such as a portable information processing apparatus or a stationary information processing apparatus. The terminal renders graphical user interface elements for inputting and displaying natural-language information requests and responses. The terminal transmits user input to the server over a communication network, such as a packet-based network, and presents response information received from the server.

The user operates the terminal to input an information request in natural language regarding, for example, attributes of public facilities or public services. The user may type or otherwise input an expression such as “What are the opening hours of the nearest park?” or “Where is the closest public library and when is it open?” into a text entry field presented by the terminal. The terminal encapsulates the text input and optional metadata, such as location data, into a data structure and transmits it to the server via the network interface.

The server receives the data structure and stores at least a portion of it in the memory. The communication control module normalizes the data into an internal format and passes the normalized inquiry information to the prompt generation module. The server represents the inquiry information as a sequence of characters or tokens and identifies contextual information, such as the user's language setting, device type, or geographic context, to be used in subsequent processing.

The server generates a first prompt sentence for a generative AI model. The prompt generation module concatenates an instruction template with the inquiry information and optionally with system-level constraints such as required output format. For example, the server generates a prompt sentence of the following structure:

“Analyze the following citizen question and extract the intent, the main target concept, and any conditions that should be used for querying a city information database. Return the result in JSON with fields ‘intent’, ‘entity_type’, and ‘conditions’. Question: ‘What are the opening hours of the nearest park?’”

In another example, the server generates a prompt sentence:

“Interpret the following user question. Identify the type of facility requested, the attributes to retrieve, and the spatial constraint. Output the result as: intent, target_type, attribute_list, spatial_constraint. Question: ‘Where is the closest public library and when is it open?’”

The server supplies the first prompt sentence as input to a generative AI model. In one embodiment, the generative AI model is implemented as a transformer-based neural network that includes an embedding layer, a plurality of self-attention layers, a feed-forward network within each layer, and an output projection layer. The server converts the prompt sentence into a sequence of discrete tokens by executing a tokenizer algorithm associated with the generative AI model, such as byte-pair encoding or unigram language model tokenization. The server maps the tokens to numerical vectors (embeddings) using an embedding matrix stored in the generative AI model's parameters.

The server causes the generative AI model to perform multi-head self-attention operations across the sequence of token embeddings. In these operations, the model computes query, key, and value vectors for each token, calculates attention weight matrices using scaled dot products, and aggregates value vectors according to the attention weights. The server applies non-linear activation functions, such as rectified linear units or other functions, and normalization layers, such as layer normalization, across multiple stacked layers. The generative AI model, thus executed on computation resources such as central processing units, graphics processing units, or tensor processing units, produces an output representation that encodes the semantic content of the prompt sentence.

The server interprets the output representation through an output head that decodes the representation into text tokens representing analysis result information. The analysis result information expresses, in a machine-readable format, at least an intent (e.g., “get_opening_hours”), a target concept (e.g., “park”), and one or more conditions (e.g., “nearest_to_user_location”). The server parses the output text into a structured representation, such as a set of key-value pairs stored in memory.

This structured representation serves as an intermediate data structure that is specifically adapted for automatic generation of structured database queries. Because the representation is machine-readable and includes explicit fields for intent, entity type, and conditions, the server can avoid the use of a fixed, manually curated mapping from user utterances to database query templates. Instead, the server dynamically maps the intermediate representation to query components, which reduces the need for rigid rule-based configuration and allows the server to adapt to schema changes in the information storage device with minimal modification.

The server constructs a database query based on the analysis result information. The query construction module receives the intent, target concept, and conditions as input. The server maintains schema metadata that describes, for each kind of target concept, corresponding tables, columns, and constraints in the information storage device. For example, for the target concept “park,” the metadata may indicate a table storing facility records with columns representing facility name, geographic location, opening time, and closing time. The server uses this metadata and the conditions (e.g., nearest to a specified location) to construct a structured query language statement that retrieves target data. The server binds location parameters and other constraint values using parameterized queries to avoid security issues and to facilitate query caching and optimization by the database engine.

In one example, the server constructs a structured query that orders facility records by geographic distance between a user location and a facility location, and limits the result set to the nearest facility. The information storage device executes the structured query, possibly employing indexes, geospatial extensions, and query planners to efficiently compute distances and filter records. The server receives the resulting records as target data and stores them in memory as structured objects for use by the response generation module.

The server generates a second prompt sentence to instruct a generative AI model to produce response information for presentation to the user. The server embeds, within the second prompt sentence, both the original inquiry information and a summarized or formatted representation of the target data. For example, the server generates a prompt sentence: “Using the following facility data from a city information database, generate a concise and polite answer for the citizen in natural English. Data: name=‘Central Park’, opening_time=‘09:00’, closing_time=‘17:00’. Question: ‘What are the opening hours of the nearest park?’” In another example, the server generates a prompt sentence:

“Given this facility information: facility_type=‘public library’, name=‘East Library’, address=‘123 Main Street’, opening_hours=‘10:00-19:00 on weekdays, 10:00-17:00 on weekends’, generate a clear and user-friendly sentence that answers the question: ‘Where is the closest public library and when is it open?’”

The server invokes a generative AI model, which may be the same or a different instance from the model used for analysis, to process the second prompt sentence. The server again performs tokenization, embedding, and transformer-based inference as described above. In response, the generative AI model produces a sequence of tokens forming response information in natural language. The server decodes the tokens into text and performs optional post-processing, such as normalization of time formats, substitution of localization-specific expressions, or truncation to a maximum length.

The terminal receives the response information via the communication network. The terminal renders the response information on a display device as part of the graphical user interface. The user reads the response information and may, if desired, provide follow-up queries. The system therefore enables iterative interactions with dynamic adaptation of the query construction and response generation based on the evolving context.

The server achieves technical improvements over conventional systems through the specific design of the intermediate representation and prompt sentences, and through the coupling of generative AI outputs with structured query generation. By specifying, within the first prompt sentence, a strict machine-readable output format and fields required for query construction, the server compels the generative AI model to emit analysis result information that can be parsed deterministically. This reduces error propagation between natural-language interpretation and database access, thereby improving precision of facility retrieval and lowering the rate of failed or irrelevant queries.

The server further reduces computation time and network load by avoiding repeated, manually defined rule evaluations and by allowing dynamic caching of structured queries and their results keyed by the machine-readable intent and condition values. Because the intermediate representation is factored into discrete fields, the server can detect when consecutive requests share identical intent and target concept with only minor changes in conditions, and accordingly reuse portions of previous query plans, thereby shortening query planning time at the information storage device.

The server also improves computing resource utilization by executing the generative AI model in batch mode across multiple concurrent user requests. By standardizing the structure of prompt sentences and output formats, the server can aggregate multiple analysis requests or response-generation requests into mini-batches, which are processed efficiently on parallel hardware such as graphics processing units. This batching reduces per-request inference overhead and improves throughput.

The generative AI model in this embodiment is trained, prior to deployment, using supervised or semi-supervised learning. The server, during model training, supplies many pairs of input prompt sentences and desired output sequences to an optimization algorithm, such as stochastic gradient descent with adaptive learning rate. The training procedure defines a loss function, for example cross-entropy between predicted token distributions and target tokens, and the optimization algorithm adjusts the model's parameters, including weights in attention layers and feed-forward networks, to minimize the loss. The server may perform data augmentation by rephrasing questions, varying facility attributes, or sampling synthetic conditions to enlarge the training set, thereby improving robustness to diverse natural-language inputs.

In another embodiment, the server fine-tunes a pre-trained generative AI model on domain-specific data related to public services and public facilities. The server curates a specialized corpus of question-answer pairs and structured records derived from the information storage device, and adjusts the model parameters so that the model learns domain-specific terminology and typical query patterns. This fine-tuning improves the model's capability to produce accurate intermediate representations and contextually appropriate response information, thus increasing the precision and recall of relevant facility data retrieval.

The server diverges from traditional rule-based systems by employing an internal rule scheme tailored to machine-readable intermediate outputs rather than human-readable decision trees. For instance, the analysis interpretation module applies a set of non-conventional parsing rules that interpret specific output keys from the generative AI model and map them to database schema components according to a metadata graph. This metadata graph encodes relationships between facility types, attribute groups, and database tables. When the generative AI model outputs a new or previously unseen target concept, the server consults the metadata graph to identify candidate tables and attributes, and composes a query without requiring human reconfiguration. This rule scheme exploits the structure of the intermediate representation and yields a different processing flow from manual human decision-making, thereby providing a machine-centric improvement in adaptability.

In a further embodiment, the server applies additional optimization algorithms to refine the structured query based on feedback from the information storage device. For example, if the database engine returns a high-cost execution plan or an empty result set, the server may modify filter conditions, adjust limits, or add fallback facilities by re-invoking the generative AI model with a modified first prompt sentence that includes execution feedback. This closed-loop mechanism, driven by machine-readable feedback and dynamic prompt adaptation, allows the system to correct misinterpretations and obtain reliable data while minimizing repeated full-cost queries.

The server provides technical benefits in data management and communication efficiency. Because the response generation module constructs prompt sentences that explicitly summarize target data in a compact form, the server does not need to transmit full raw records to the generative AI model. Instead, the server pre-selects relevant attributes, such as facility name and opening hours, and excludes unneeded columns. This selective summarization reduces the volume of data transferred between the server and the generative AI environment and decreases memory usage and processing time within the model. Additionally, by controlling the maximum length and granularity of target data included in the second prompt sentence, the server ensures deterministic processing latency for response generation.

Alternative implementations are possible within this framework. In one variation, the generative AI model is executed entirely on the server's hardware, using specialized inference libraries on a graphics processing unit. In another variation, the generative AI model is executed on a remote computation service, and the server communicates with this service via application programming interfaces. In another variation, the information storage device includes both relational databases and non-relational data stores; the server selects an appropriate query language and access protocol based on the target concept indicated in the analysis result information. In still another variation, the server maintains multiple language-specific prompt templates and selects a template based on user language settings, while reusing the same intermediate representation and query construction logic.

The terminal may, in some embodiments, cache portions of response information along with classification metadata, such as the intent and target concept, enabling the terminal to locally answer frequently repeated questions without contacting the server for every request. In these embodiments, the server periodically updates the cached metadata and canonical responses according to changes in facility data, ensuring that the terminal maintains accurate and current information. This arrangement further reduces network load and latency for common queries.

By designing the system around prompt sentences that enforce structured outputs, machine-readable intermediate representations that guide automatic query construction, and transformer-based generative AI models that are trained or fine-tuned to respect these structures, the server enhances the internal operation of the computing system itself. The combination of standardized prompts, domain-specific model tuning, dynamic query generation, and feedback-based refinement produces measurable improvements in query accuracy, processing latency, and computational resource utilization, beyond merely replicating human information lookup behavior.

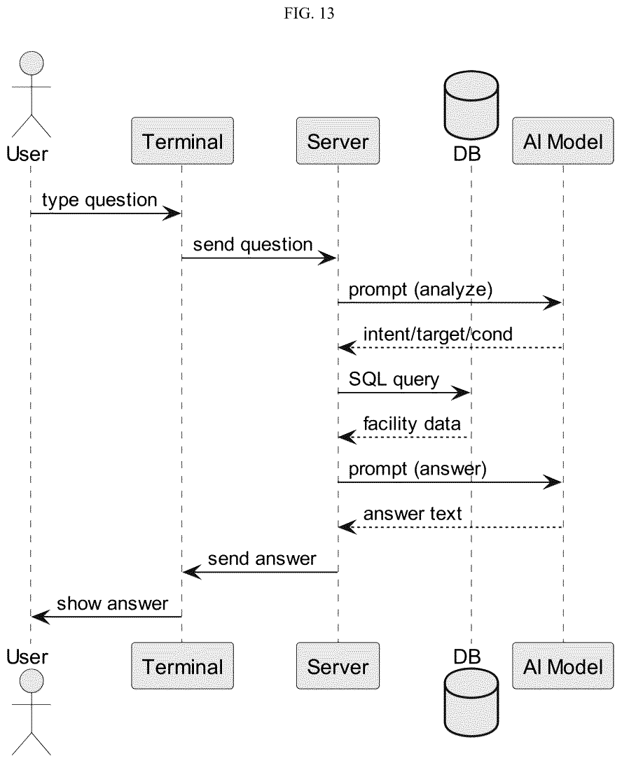

The following describes the processing flow using FIG. 13.

### Step 1

The user operates the terminal to input an information request in natural language.

The user types a sentence such as “What are the opening hours of the nearest park?” into an input field displayed on the terminal screen and actuates a send control (for example, a button).

The input of this step is a natural-language text string entered by the user through a graphical user interface.

The output of this step is a data structure held in the terminal's memory that contains at least the text string and optional metadata such as a language code and a location value.

### Step 2

The terminal generates a request message including the user's input and transmits the request message to the server.

The terminal converts the data structure from Step 1 into a serialized representation, attaches a destination identifier for the server, and sends the serialized representation over a communication network.

The input of this step is the local data structure containing the user's question and metadata.

The output of this step is a request message, transmitted via the network interface, that encodes the question text and metadata as a sequence of bits according to a predetermined communication protocol.

### Step 3

The server receives the request message from the terminal and reconstructs the inquiry information.

The server decodes the communication protocol, parses the message payload, and converts the serialized representation back into an internal data structure that includes the natural-language question and metadata fields.

The input of this step is the incoming request message represented as a network data stream. The output of this step is an internal inquiry data object stored in the server's memory, containing the question text, a user identifier (if available), and contextual parameters such as a location coordinate.

### Step 4

The server normalizes the inquiry information and prepares it for prompt generation.

The server applies text normalization operations, such as converting character encodings, trimming whitespace, and unifying punctuation, and associates the normalized text with contextual information (for example, time zone and language setting).

The input of this step is the inquiry data object from Step 3.

The output of this step is a normalized inquiry record that includes a cleaned question string and structured context fields, which will be used as input to the prompt generation module.

### Step 5

The server generates a first prompt sentence for a generative AI model based on the normalized inquiry record.

The server selects a prompt template corresponding to a type of task (for example, intent extraction and condition extraction) and inserts the question text and required output format specification into the template by string formatting.

For example, the server may generate the following prompt sentence:

“Analyze the following citizen question and extract the intent, the main target concept, and any conditions that should be used for querying a city information database. Return the result in JSON with fields ‘intent’, ‘entity_type’, and ‘conditions’. Question: ‘What are the opening hours of the nearest park?’”

The input of this step is the normalized inquiry record with the question string and context.

The output of this step is a first prompt sentence represented as a text string ready to be supplied to the generative AI model.

### Step 6

The server tokenizes the first prompt sentence and supplies the token sequence to the generative AI model.

The server applies a tokenizer associated with the generative AI model, converting the text into a sequence of token identifiers, and packs the sequence into a model input tensor structure along with positional indices.

The input of this step is the prompt sentence text string from Step 5.

The output of this step is a numerical token sequence (for example, an array of integers) stored in memory and passed to the generative AI model as input data.

### Step 7

The server causes the generative AI model to perform inference on the token sequence and compute analysis result information.

The generative AI model, implemented as a multi-layer transformer network, maps the token identifiers to embeddings and processes them through multiple attention and feed-forward layers to compute output token probabilities. The model generates tokens that encode a machine-readable description of the intent, target concept, and conditions.

The input of this step is the model input tensor containing token identifiers and positional information from Step 6.

The output of this step is a sequence of output tokens representing analysis result information, which the server decodes into a text string such as:

“{“intent”: “get_opening_hours”, “entity_type”: “park”, “conditions”: [“nearest_to_user_location”]}”.

### Step 8

The server parses the analysis result text into a structured intermediate representation.

The server interprets the output text as a structured format, extracts values corresponding to fields such as intent, entity_type, and conditions, and stores them in a machine-readable data structure such as a key-value map.

The input of this step is the analysis result text string produced by the generative AI model in Step 7.

The output of this step is an intermediate representation object that explicitly encodes an intent label, a target concept label, and a list or set of condition descriptors for use in query construction.

### Step 9

The server determines database access parameters based on the intermediate representation and schema metadata.

The server consults stored schema information to map the target concept to one or more database tables and maps the intent to a type of operation (for example, selection of records and extraction of specific attributes). The server also translates condition descriptors into filter expressions and parameter bindings.

The input of this step is the intermediate representation object from Step 8 and the database schema metadata.

The output of this step is a query specification object containing table identifiers, attribute identifiers (such as opening_time and closing_time), and constraint definitions (such as distance-based ordering with a limit of one record).

### Step 10

The server constructs a structured query language statement from the query specification object.

The server assembles a text query by combining table names, column names, and condition clauses and by allocating placeholders for parameter values that will be bound at execution time. The server ensures that the generated query respects syntactic rules and uses parameterized constructs to avoid injection vulnerabilities.

The input of this step is the query specification object from Step 9.

The output of this step is a structured query language statement represented as a text string, along with a set of parameter values such as geographic coordinates.

### Step 11

The server executes the structured query language statement on the information storage device and retrieves target data.

The server sends the query string and parameter values to a database engine, which performs index lookups, joins (if needed), and calculations such as distance functions to find relevant records. The database engine returns one or more rows of data to the server.

The input of this step is the structured query language statement and its parameters from Step 10.

The output of this step is a result set object in the server's memory that contains target data fields, for example a facility name and corresponding opening and closing times.

### Step 12

The server summarizes and formats the target data for use in a second prompt sentence.

The server selects relevant fields from the result set, such as facility_name, opening_time, and closing_time, converts internal representations into standardized textual formats, and combines them into a concise summary string.

The input of this step is the result set object from Step 11.

The output of this step is a formatted data summary string, such as “name =‘Central Park’, opening_time=‘09:00’, closing_time=‘17:00’”, which will be embedded in the second prompt sentence.

### Step 13

The server generates a second prompt sentence to instruct the generative AI model to create response information.

The server selects a response-generation template, inserts the formatted data summary and the original question text, and constructs a natural-language instruction for the model.

For example, the server may generate the following prompt sentence:

“Using the following facility data from a city information database, generate a concise and polite answer for the citizen in natural English. Data: name=‘Central Park’, opening_time=‘09:00’, closing_time=‘17:00’. Question: ‘What are the opening hours of the nearest park?’” The input of this step is the formatted data summary string from Step 12 and the normalized inquiry record from Step 4.

The output of this step is a second prompt sentence text string for response generation.

### Step 14

The server tokenizes the second prompt sentence and performs inference with the generative AI model to generate a natural-language response.

The server converts the second prompt sentence into token identifiers, supplies them to the generative AI model, and causes the model to compute output tokens representing a fluent answer based on both the data and the question.

The input of this step is the second prompt sentence text string from Step 13.

The output of this step is a sequence of output tokens that the server decodes into a response text, for example: “The nearest park, Central Park, is open from 9:00 a.m. to 5:00 p.m.”

### Step 15

The server post-processes the response text and prepares a response message for the terminal. The server may adjust formatting (such as time expressions), ensure that the length does not exceed a predetermined threshold, and encapsulate the text along with auxiliary metadata such as a response identifier into a message structure.

The input of this step is the raw response text from Step 14.

The output of this step is a structured response message, containing the finalized response information, ready for transmission to the terminal.

### Step 16

The server transmits the structured response message to the terminal via the communication network.

The server encodes the response message according to a communication protocol, sets appropriate headers or control information, and sends the encoded message through a network interface toward the terminal.

The input of this step is the structured response message from Step 15.

The output of this step is a network data stream carrying the response information from the server to the terminal.

### Step 17

The terminal receives the response message and reconstructs the response information.

The terminal decodes the communication protocol, parses the message payload, and recovers the response text from the structured representation.

The input of this step is the incoming network data stream received from the server in Step 16.

The output of this step is a response text string stored in the terminal's memory, along with any associated metadata such as a timestamp.

### Step 18

The terminal displays the response information to the user through a graphical user interface. The terminal updates user interface elements, such as a text area or dialog box, by inserting the response text and optionally adjusting layout or visual emphasis so that the answer is clearly visible.

The input of this step is the response text string from Step 17.

The output of this step is a visual presentation of the response on the terminal's display, enabling the user to read and understand the information provided.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems and information-provision systems that rely on natural language processing typically execute a fixed pipeline in which user text is parsed, a database is queried, and a static template is filled to generate a response. Such systems exhibit several technical deficiencies.

First, conventional systems have limited ability to accurately capture user intent and context when user input is ambiguous, multi-faceted, or expressed in natural language that does not match predefined patterns. Rule-based or narrowly trained classifiers often fail to extract sufficient structured data (such as intent, entities, and constraints), which leads to incorrect or incomplete database queries and degraded system output quality.

Second, even when a system additionally calculates sentiment or emotion, that information is generally treated as auxiliary metadata and is not deeply integrated into the core response-generation logic. As a result, the emotion data does not systematically influence how information is selected, prioritized, or linguistically realized. The communication behavior of the system therefore remains largely static regardless of user emotional state.

Third, many existing architectures separate intent detection, database access, and response generation into loosely coupled components, each of which is configured independently. This separation makes it difficult to coordinate factual retrieval with natural language generation, and leads to increased latency and processing overhead. In particular, generative models are often invoked with incomplete or unstructured context, forcing the models either to hallucinate missing facts or to generate verbose and inconsistent answers, which in turn reduces reliability.

Fourth, conventional systems do not provide a robust mechanism to systematically construct and supply a machine-readable, context-rich prompt to a generative AI model. Without an explicit prompt sentence that integrates user text, structured intent data, database results, and emotion data, the generative model cannot reliably produce concise and accurate answers tailored to both informational needs and emotional needs of the user.

Fifth, user interfaces of known systems generally treat all responses uniformly, without dynamic adjustment of presentation order or emphasis based on user state. Even if a user is in a hurry, key numerical information (such as price, opening hours, or availability) may be buried in the middle or end of the response, increasing the time required for the user to extract relevant information and reducing overall system usability and efficiency from a computer-human interaction perspective.

Accordingly, there is a need for a computerized information-provision system and processing method that technically improves the way a processor: (i) consolidates user text, structured intent data, database results, and emotion data; (ii) constructs and supplies a detailed prompt sentence to a generative AI model; and (iii) automatically restructures and presents the generated answer according to user emotion, particularly urgency. Such improvements should reduce misinterpretation of user queries, reduce hallucinated content from the generative model, lower response latency, and enhance the effectiveness and efficiency of the system's human-computer interaction behavior, thereby constituting a concrete improvement in computer technology itself rather than a mere automation of mental steps.

The specific processing by the specific processing unit 290 of the data processing device 12 in Application Example 2 is realized by the following means.

The present invention provides a server comprising a processor configured to receive inquiry information transmitted from a user terminal via a communication network; to perform preprocessing and language analysis on text data included in the inquiry information so as to generate structured data representing an intent of the inquiry and target information of the inquiry; to perform emotion analysis processing on the text data so as to generate emotion data indicating an emotional state of a user; to search an information storage device for information resources based on the structured data and to acquire information data related to the inquiry; to generate a prompt sentence including the text data, the structured data, the emotion data, and the information data, and to supply the prompt sentence as input to a generative AI model so as to cause the generative AI model to generate answer text; to generate response data by adjusting an expression format or a presentation order of the answer text according to the emotion data, including, when the emotion data indicates user urgency, reconstructing the answer text such that main numerical information or important items appear at a beginning of the answer text; and to transmit the response data together with presentation control information to the user terminal as response information for display or audio output. This enables the server to technically improve natural language interaction by centrally integrating intent analysis, emotion recognition, and database retrieval into a unified prompt construction for the generative AI model, thereby reducing hallucinated or irrelevant content, lowering end-to-end response time, and adaptively restructuring and emphasizing machine-generated outputs in accordance with user emotion so that key factual information is surfaced earlier and more prominently, resulting in an enhanced and more efficient computer-implemented dialog behavior.

The term “user terminal” refers to an information processing apparatus operated by a user, such as a computing device having an input unit, a display unit, and a communication unit, that transmits inquiry information to a server and receives response information from the server via a communication network.

The term “communication network” refers to a wired or wireless data communication infrastructure, including one or more networks such as a local area network, a wide area network, or a public packet-switched network, that enables the exchange of digital data between the user terminal and the server.

The term “inquiry information” refers to data transmitted from the user terminal toward the server, the data including at least user-provided text data expressing a question, request, or demand for information, and optionally including metadata such as a user identifier, a terminal identifier, or contextual information.

The term “text data” refers to a sequence of characters representing natural language content provided by the user, and may include letters, numerals, symbols, or encoded representations thereof suitable for computational processing.

The term “preprocessing” refers to automated processing performed on text data prior to higher-level language analysis, the processing including at least one of normalization, tokenization, sentence segmentation, part-of-speech tagging, or language detection so as to convert the text data into a form suitable for subsequent analysis.

The term “language analysis” refers to computational processing that interprets the semantic and syntactic properties of text data, including at least intent classification, entity extraction, and determination of relationships among words or phrases, in order to derive structured data from the text data.

The term “structured data” refers to data representing information extracted from text data in a machine-readable format, such as a set of key-value pairs, a record, or a structured object, the data including at least an intent of an inquiry and target information related to the inquiry.

The term “intent of the inquiry” refers to a machine-interpretable representation of a purpose or goal of a user's inquiry, such as requesting a price, requesting operating hours, requesting availability information, or requesting guidance, which is derived from the text data through language analysis.

The term “target information” refers to an object, item, facility, or concept to which the user's inquiry is directed, such as a particular product, a location, a facility type, or a service category, as represented in the structured data.

The term “emotion analysis processing” refers to processing performed by a computing resource that analyzes text data to infer an emotional state of a user, using at least one of machine learning, rule-based analysis, or statistical analysis, and outputs corresponding emotion data.

The term “emotion data” refers to data indicating an estimated emotional state of a user, including at least one of an emotion category, such as urgency, anxiety, satisfaction, or anger, and a numerical score or index representing an intensity or degree of the emotional state.

The term “information storage device” refers to a data storage subsystem, such as a memory device or a persistent storage device, that stores information resources including records, tables, or documents containing factual data used to respond to user inquiries.

The term “information resources” refers to organized data sets or records stored in the information storage device, such as entries in a database or other structured data store, that include factual information relevant to possible user inquiries.

The term “information data” refers to data retrieved from the information storage device based on structured data derived from an inquiry, the data including at least one factual value or attribute related to the intent of the inquiry and the target information.

The term “prompt sentence” refers to a text string or composite text data constructed by the processor to be supplied as input to a generative AI model, the text string including at least user-originated text data, structured data, emotion data, and information data, together with instructions or task descriptions for answer generation.

The term “generative AI model” refers to a machine-learned model configured to generate natural language text in response to input data, the model having been trained on text data and being capable of producing answer text that reflects constraints and information provided in a prompt sentence.

The term “answer text” refers to natural language text generated by the generative AI model in response to a prompt sentence, the text being intended as a candidate response to a user inquiry before any emotion-based restructuring or formatting adjustments.

The term “response data” refers to data generated from the answer text by the processor, the data including at least the answer text as potentially modified in expression format or presentation order according to emotion data, and optionally including presentation control information for use by the user terminal.

The term “expression format” refers to a manner in which content of the answer text is phrased or styled, including at least a tone, politeness level, verbosity, sentence structure, or language selection, which can be adjusted based on emotion data.

The term “presentation order” refers to an order or sequence in which elements of the answer text, such as numerical values, important items, or explanatory sentences, are arranged, the order being modifiable according to emotion data such as user urgency.

The term “main numerical information” refers to numerical values or quantitative data within the answer text that are most relevant to a user inquiry, such as prices, times, quantities, or numerical indicators of availability.

The term “important items” refers to non-numerical elements of content within the answer text that are determined to be particularly significant or essential for satisfying the user's inquiry, such as key conditions, limitations, or primary recommendations.

The term “presentation control information” refers to metadata or control data transmitted together with response data to the user terminal, the metadata or control data indicating at least how the answer text should be displayed or output, including instructions for emphasis, highlighting, ordering, or modality of presentation.

The term “display” refers to an output interface of the user terminal that visually presents information to the user, such as a screen, monitor, or other visual display unit capable of rendering text and graphical elements.

The term “audio output” refers to an output modality in which answer text is converted into sound signals, including through text-to-speech processing and playback via a speaker or headphone device associated with the user terminal.

The term “task description” refers to a portion of a prompt sentence that explicitly specifies behavior expected from the generative AI model, including instructions regarding a target language, a desired length of the answer text, a tone or style of expression, and constraints on use of provided information.

In one embodiment, a server, one or more terminals, and one or more communication networks cooperate to implement the claimed system. The server includes at least one processor, a main memory, a non-volatile storage device, and a network interface. The terminal includes at least one processor, a memory, a display, an input device such as a keyboard, touch panel, or microphone, and a communication interface. The communication network includes at least one of a local area network and a wide area network that supports packet-based communication such as HTTP over TCP/IP.

The server executes an application program stored in the non-volatile storage device and loaded into the main memory. The application program includes modules for natural language preprocessing, intent and entity extraction, emotion analysis, database access, prompt sentence construction, generative AI model interaction, and response post-processing. The server may execute an operating system and an application stack including, for example, a web server software, a runtime environment for an interpreted language, and libraries for numerical computation and machine learning. The server may use a natural language processing library such as a tokenization and parsing library, a numerical computation library such as a tensor operation library, and a deep learning framework such as a general-purpose neural network framework.

The terminal executes a client application such as a web browser or native application that provides a user interface. The terminal displays an input field for a user inquiry, receives input from a user via the touch panel, keyboard, or microphone, converts speech to text when necessary using a speech-to-text engine, and transmits the resulting text to the server via the communication interface. The terminal receives a response from the server and displays the response on the display. In some cases, the terminal converts text to speech using a text-to-speech engine and outputs audio to a speaker.

The server uses specific data structures to manage inquiry information and processing context. The server stores inquiry information received from the terminal in a memory-resident object that includes a text field for user text, a metadata field for a user identifier and device identifier, and an optional context field for conversation history identifiers. The server converts the text field into a token sequence by using a tokenizer, and associates each token with part-of-speech tags and character offsets in the original text. The server stores the result in a structured data object that includes a token list, tag list, and semantic slots for intent and entities.

The server analyzes the text to extract an intent of the inquiry and target information using a neural network model. In one embodiment, the server uses a transformer-based neural network as an intent and entity classifier. The neural network may have an embedding layer that maps tokens to dense vectors, multiple self-attention layers that compute contextualized representations, and a classification head that outputs probability distributions over predefined intent categories and entity types. The server uses a cross-entropy loss function during training to optimize weights, and applies backpropagation and gradient descent or a variant thereof, such as Adam optimization, to update network parameters. The server may perform data augmentation during training by paraphrasing user utterances and adding noise to improve robustness. The server stores learned weights in the non-volatile storage device and loads them into memory at runtime.

The server generates emotion data using another neural network model or a shared model with multiple output heads. In one embodiment, the server uses a neural network that takes as input the same contextualized token representations and outputs both a categorical emotion label (for example, neutral, urgent, anxious, angry) and a continuous urgency score in a fixed range. The server trains this model using supervised learning on labeled text data, with one or more loss functions that include a categorical cross-entropy loss for the label and a mean squared error loss for the score. The server combines these losses with weighting coefficients and updates weights by gradient descent. The server thus obtains weights that are specifically tuned to detect urgency and other emotions with high accuracy and low false-positive rate. By using dedicated neural network architectures and separate outputs for intent and emotion, the server improves internal representation sharing and reduces computational redundancy. The server can compute shared contextual embeddings once and use them for both intent and emotion predictions, thereby reducing processing time and memory access overhead compared to running separate independent models. This architectural design constitutes a technical improvement in the way the server processes natural language compared to a naïve pipeline that calls separate external services without shared computation.

The server accesses an information storage device to retrieve information resources relevant to the structured data. The information storage device may include a relational database management system storing tables for products, facilities, services, and other entities. The server maps the structured intent and entities to a database query template and substitutes entity values into placeholders. The server then executes the query via a database driver and receives result rows that include factual information such as prices, opening hours, availability, or location coordinates. The server converts result rows into an internal information data object that contains key-value pairs for each attribute.

The server constructs a prompt sentence for a generative AI model by composing multiple data fields into a single text sequence according to predefined rules. The server includes the original user text, a textual representation of the intent and target information, a textual representation of information data from the database, a description of the emotion data, and a task description. The server uses a template or programmatically generated structure to ensure that each element appears in a consistent order, with explicit labels that the generative AI model can parse. For example, the server may generate a prompt sentence such as:

User question: “How much is this product?”

Intent: price inquiry.

Target: product identified by internal ID 12345.

Database information: price=1000 yen.

User emotion: neutral (urgency score=0.10).

Task: Using only the above information, generate a short, clear answer in Japanese that directly tells the user the price.

In another example, the server may generate a prompt sentence such as:

User question: “What are the opening hours of the nearest park?”

Intent: inquiry about opening hours.

Target: nearest park to current user location.

Database information: nearest park name=Central Park; opening hours=9:00-17:00.

User emotion: in a hurry (urgency score=0.87).

Task: Using only the above information, generate a very short answer in English that begins with the opening hours and avoids unnecessary detail.

The server transmits the prompt sentence to a generative AI model interface. The generative AI model may be a transformer-based sequence-to-sequence neural network trained on large-scale text data. The generative AI model receives the prompt sentence as input tokens, computes attention-based transformations across multiple layers, and generates answer text tokens step by step based on learned probability distributions. The generative AI model employs parameter matrices representing layer weights, attention weights, and feed-forward networks. During its original training phase, the model uses objective functions such as next-token prediction loss and is updated by backpropagation. Although training may be performed offline, the architecture and learned parameters determine runtime behavior.

The server benefits from using structured prompt sentences with explicit fields because the server can impose deterministic constraints on the input context. As a result, the generative AI model is provided with authoritative factual values and explicit instructions about language, style, and length. This systematic combination reduces hallucination of incorrect values and improves consistency across responses. Moreover, by computing structured intent, emotion, and information data, the server can reuse intermediate representations for analytics and logging without re-parsing natural language output, thereby improving data management and traceability compared to a system that only stores raw user text and raw generative outputs.

The server generates response data by analyzing the answer text produced by the generative AI model and adjusting its expression format or presentation order based on the emotion data. The server may parse the answer text into tokens and identify numerical expressions and key phrases that refer to important items. The server may use pattern matching, numerical entity recognition, or a lightweight classifier to detect main numerical information and important items. When the emotion data indicates a high urgency score, the server moves main numerical information and important items to earlier positions in the answer text. For example, the server may rewrite an answer such as “The nearest park is Central Park, and it is open from 9:00 to 17:00” into “It is open from 9:00 to 17:00. The nearest park is Central Park.” The server thereby ensures that the most relevant factual information appears at the beginning.

The server may also adjust the tone and politeness level by applying rules that add or remove polite phrases depending on the emotion category. When the emotion data indicates anxiety, the server may append a reassuring sentence such as “If you have any concerns, please contact support.” When the emotion data indicates neutral state, the server may generate a concise answer without additional reassurance. The server thus uses emotion data as an explicit control signal for text formatting and content arrangement, not merely as metadata for offline analysis.

The server generates presentation control information that indicates how the terminal should present the answer text. The server may set flags for emphasis, such as bold display of specific phrases, larger font size for main numerical information, or color highlighting of important items. The server may also instruct the terminal to use audio output in addition to visual display when the emotion data indicates that multimodal presentation could reduce user effort. The server includes presentation control information in the response data transmitted to the terminal.

The terminal receives the response data and uses the presentation control information to present the answer in a way that is optimized for the user's emotional state and information needs. For example, when the server indicates urgency, the terminal may display the key numerical information at the top of the screen in a large font and may omit secondary details initially. When the server indicates anxiety, the terminal may display the answer text and an icon or color scheme associated with reassurance.

The described configuration provides technical advantages beyond a mere automation of human reasoning. The server uses specialized data structures for structured data, emotion data, and information data, empirical neural network architectures sharing internal representations for joint tasks, and deterministic prompt sentence construction. By combining these elements, the server reduces processing time, decreases the probability of incorrect responses, and increases stability under high query loads. The shared embedding and multi-head architectures reduce the number of network calls and the volume of intermediate data transmission, which reduces communication load and improves throughput.

The server achieves improved accuracy in intent and emotion detection by using trained neural networks that exploit high-dimensional feature representations and non-linear decision boundaries. The server uses explicit loss functions, weight regularization, and data augmentation to lower generalization error and reduce bias. As a result, the server can correctly classify nuanced intentions and subtle emotional cues that are difficult to capture with rule-based or linear models.

The server improves computational efficiency by reusing contextual embeddings for multiple tasks and by constructing a single prompt sentence that consolidates all relevant context for the generative AI model. This design reduces redundant inference passes and minimizes the number of external model calls. The reduced overhead results in faster average response times and more predictable latency, which is a specific technical improvement in computer operation.

The system also enables improved data management and traceability. Because the server constructs structured data and prompt sentences explicitly, the server can store, index, and search these objects in a structured log system. This allows efficient debugging and monitoring, as engineers can analyze which combination of intent, emotion, and information data led to which generative output. Such logging is more precise than storing only free-form text conversations and enables optimization of model configurations and thresholds.

The server, terminal, and communication network together perform a specific sequence of machine-implemented operations with defined data flows and internal transformations. The server does not simply replace a human operator's judgment with an opaque “AI decision” but implements a layered architecture: deterministic preprocessing, well-defined neural network inferences, deterministic prompt construction, and rule-based post-processing. Each layer uses specific algorithms and representations that can be implemented, tested, and optimized on computing hardware. This combination of structures and effects leads to concrete technical improvements in the way the computing system processes language, retrieves data, and manages presentation.

Multiple variations of the embodiment are possible. The server may implement different neural network architectures, such as recurrent networks, convolutional networks, or hybrid architectures, provided that the models output structured intent and emotion data usable for downstream processing. The server may employ different database technologies, such as document databases or graph databases, as long as information resources can be queried based on structured data. The server may also support multiple generative AI models and select a specific model based on user language, device type, or application domain.

The terminal may be a smartphone, tablet, personal computer, kiosk terminal in a physical store, or any other device capable of sending text and receiving responses. The communication network may include mobile communication networks and wireless local networks. The server may be deployed on a cloud computing environment, an on-premise data center, or an edge computing environment closer to physical terminals. All such variations are considered within the scope of the described embodiments, as long as the processor of the server performs the functions of generating structured data, emotion data, information data, prompt sentences, and response data as set forth in the claims.

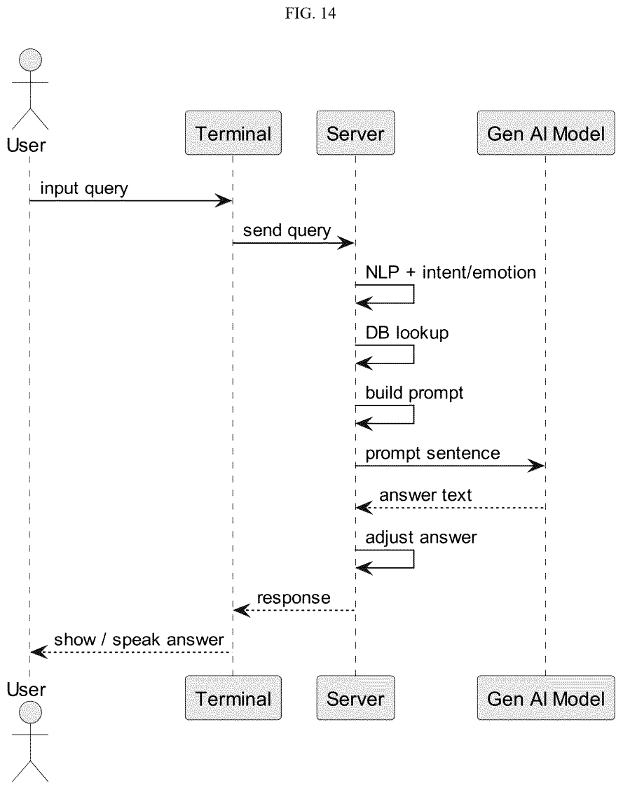

The following describes the processing flow using FIG. 14.

### Step 1

User operates the terminal to input an inquiry.

User types a natural-language question into an input field, or speaks into a microphone, such as “What are the opening hours of the nearest park?” or “How much is this product?”.

Terminal receives the raw user input as either audio data or character data. As input, the terminal obtains speech waveforms or keystroke events. The terminal converts speech waveforms into text using a speech-to-text engine, and aggregates characters or recognized words into a string. As output, the terminal produces a text string representing the user inquiry together with metadata such as a timestamp, device identifier, and optional location data.

### Step 2

Terminal packages and transmits the inquiry information to the server.

Terminal constructs a request object including the text string, the metadata, and a session or conversation identifier if available. As input, the terminal uses the text string and metadata generated in Step 1. The terminal serializes this object into a message format such as JSON and encapsulates it into an HTTP request over a communication protocol. The terminal then sends the HTTP request via the communication network to an API endpoint of the server. As output, the terminal produces a network message that is delivered to the server.

### Step 3

Server receives the inquiry information and stores it in a processing context.

Server accepts the HTTP request through a network interface, and a web server component parses the headers and body. As input, the server obtains the serialized request object received from the terminal. The server deserializes the body to extract the text field, metadata, and session identifier, and then instantiates an internal context object in memory. As data processing, the server maps each field from the request into corresponding fields of the context, assigns a unique internal request ID, and logs the event for monitoring. As output, the server holds a structured context object that will be referenced in subsequent steps.

### Step 4

Server performs text preprocessing and tokenization.

Server reads the text field from the context object as input. The server normalizes the text by converting it to a standard encoding, removing control characters, and optionally lowercasing characters. The server then invokes a tokenizer from a natural language processing library to segment the text into tokens, and may also perform sentence splitting and part-of-speech tagging. As data processing, the server converts the string into a list of token objects, each containing the token text, start and end offsets, and grammatical tags. As output, the server updates the context with a token list and associated linguistic annotations.

### Step 5

Server performs language analysis to derive structured intent and target information.

Server uses the token list and annotations from Step 4 as input to an intent and entity extraction module. The server feeds the token sequence into a trained neural network, such as a transformer-based classifier, which computes contextual embeddings and outputs probability distributions over possible intent labels and entity types. As data processing, the server selects the intent label with the highest probability and decodes span-level entity predictions into typed entities, such as a facility type or product identifier. The server then constructs structured data with fields such as “intent=ASK_OPENING_HOURS” and “target=nearest park”. As output, the server stores this structured data in the context object.

### Step 6

Server performs emotion analysis to generate emotion data.

Server takes the original text and optionally the contextual embeddings produced in Step 5 as input into an emotion analysis module. The server passes these features through a neural network configured to output an emotion label and a continuous urgency score. As data processing, the server calculates logit values for each emotion category, applies a softmax function to obtain emotion probabilities, and applies an activation function such as a sigmoid or linear mapping to estimate an urgency score. The server selects the highest-probability emotion category and pairs it with the urgency score, for example “emotion=in a hurry, urgency_score=0.87”. As output, the server stores this emotion data in the context.

### Step 7

Server accesses an information storage device to retrieve information data.

Server reads the structured data from Step 5 as input to a database access module. The server translates the intent and target information into a query template and fills parameter values such as a product identifier or geographic location. The server then sends the query to a database management system and receives result rows. As data processing, the server parses the result rows and extracts relevant attributes, such as prices, opening hours, or availability flags. The server constructs an information data object, e.g., “park_name=Central Park, opening_hours=9:00-17:00”. As output, the server attaches this information data to the context object.

### Step 8

Server constructs a prompt sentence for the generative AI model.

Server uses as input the original text, structured data, emotion data, and information data stored in the context. The server applies deterministic rules to arrange these elements into a single text sequence with explicit labels and a task description. As data processing, the server concatenates labeled lines, converts non-textual values such as times and numerical scores into human-readable strings, and appends instructions about language, length, and tone. For example, the server may construct:

“User question: ‘What are the opening hours of the nearest park?’

Intent: inquiry about opening hours.

Target: nearest park to current user location.

Database information: nearest park name=Central Park; opening hours=9:00-17:00.

User emotion: in a hurry (urgency score=0.87).

Task: Using only the above information, generate a very short answer in English that begins with the opening hours and avoids unnecessary detail.”

As output, the server produces a prompt sentence string stored in the context for use by the generative AI model interface.

### Step 9

Server transmits the prompt sentence to the generative AI model and receives answer text. Server takes the prompt sentence from Step 8 as input and passes it to a generative AI model interface. The server tokenizes the prompt sentence according to the model's vocabulary, then sends the token sequence and model parameters such as maximum length and temperature to a generative model endpoint. As data processing, the generative AI model computes internal hidden states, attention scores, and output token probabilities layer by layer, and the server collects the generated token sequence from the model's output. The server then decodes the tokens back into text, obtaining answer text such as “The opening hours of the nearest park are from 9:00 to 17:00.” As output, the server adds the answer text to the context object.

### Step 10

Server post-processes the answer text based on emotion data to generate refined answer text.

Server uses the answer text from Step 9 and the emotion data from Step 6 as input. When the urgency score exceeds a threshold, the server analyzes the answer text for numerical expressions and key phrases that correspond to important items. As data processing, the server may apply regular expressions or a lightweight parser to identify time ranges, prices, or availability terms, then adjust sentence order so that such information appears at the beginning of the text. For example, the server may transform “The nearest park is Central Park, and it is open from 9:00 to 17:00” into “It is open from 9:00 to 17:00. The nearest park is Central Park.” The server may also insert or remove polite or reassuring phrases based on the emotion category. As output, the server obtains refined answer text that is aligned with user urgency and emotional state.

### Step 11

Server generates response data including presentation control information.

Server takes the refined answer text from Step 10 as input and builds a response object for transfer to the terminal. The server determines presentation control information by mapping emotion data to display behavior, such as flagging main numerical information for emphasis or specifying that certain parts of the answer should be highlighted. As data processing, the server assembles the answer text together with metadata specifying display style, such as priority level, font emphasis flags, or audio playback hints. As output, the server produces a serialized response message containing both the refined answer text and presentation control information.

### Step 12

Server transmits the response data to the terminal.

Server uses the serialized response message from Step 11 as input to an HTTP response mechanism. The server sets appropriate headers, inserts the serialized data into the response body, and sends the response back over the communication network to the originating terminal. As data processing, the server ensures correct encoding and session correlation by including the original request ID or session identifier. As output, the server places the response message on the network toward the terminal.

### Step 13

Terminal receives and interprets the response data.

Terminal accepts the HTTP response as input from the communication network. The terminal parses the headers and body, deserializes the response object, and extracts the refined answer text and the presentation control information. As data processing, the terminal maps presentation flags to user interface instructions, such as selecting font size, color, or layout positions. As output, the terminal obtains internal UI directives and associated text content ready for rendering.

### Step 14

Terminal presents the answer to the user using visual and/or audio output.

Terminal uses the refined answer text and UI directives from Step 13 as input. The terminal renders the text on the display, for example placing key numerical information at the top in a larger font and showing secondary details below. When instructed, the terminal invokes a text-to-speech engine to synthesize audio and plays the synthesized voice through a speaker. As data processing, the terminal converts textual characters into graphical glyphs or audio waveforms according to the control information. As output, the terminal produces a visible and/or audible presentation that conveys the answer to the user in a form optimized for the detected emotion and urgency.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

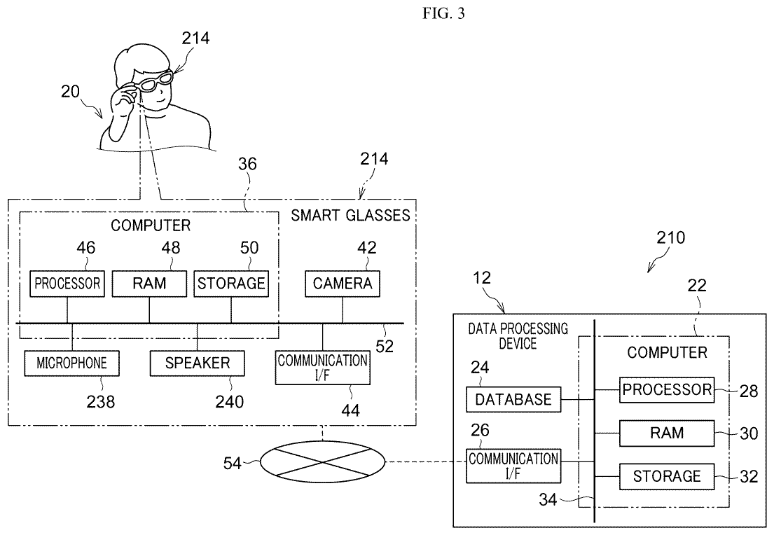

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

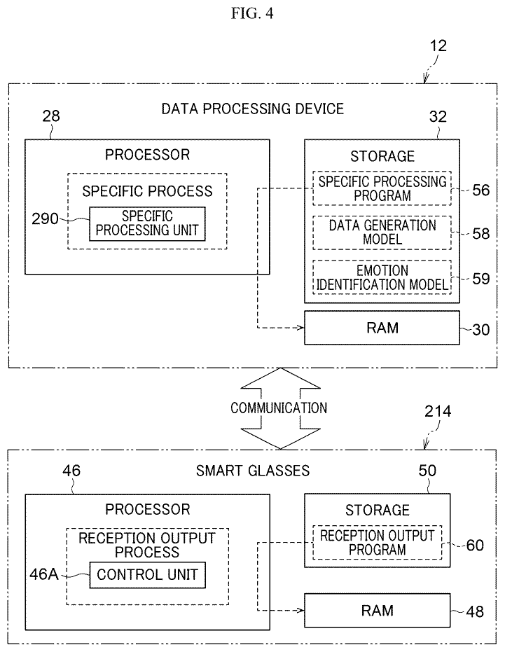

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

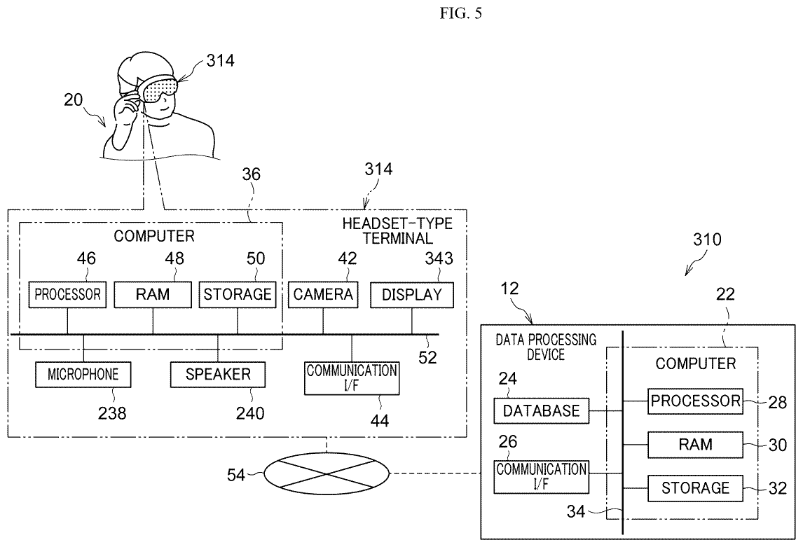

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

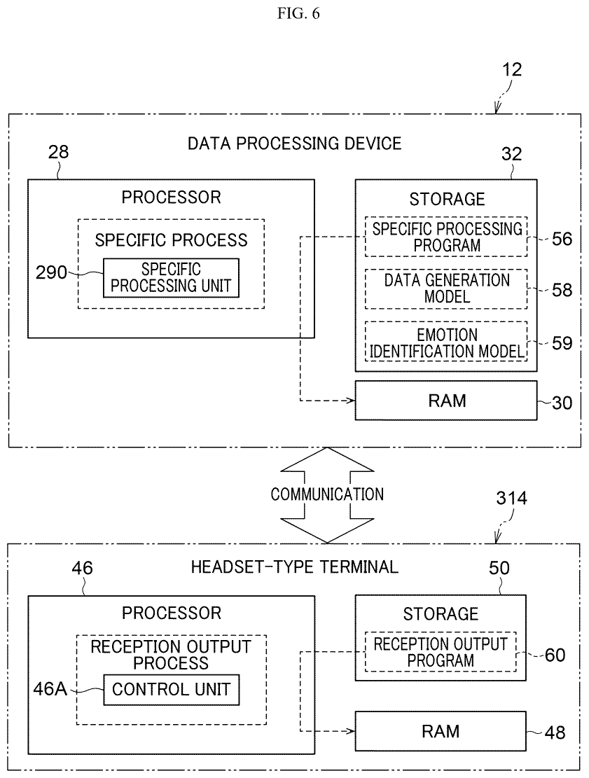

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

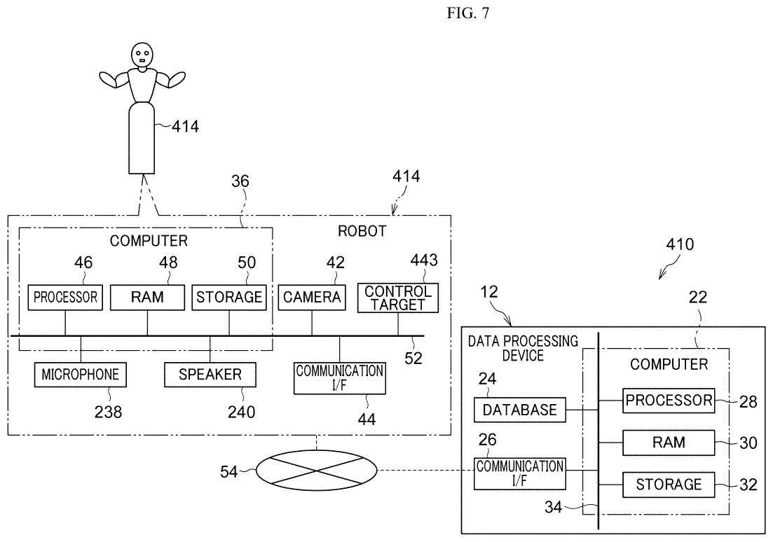

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

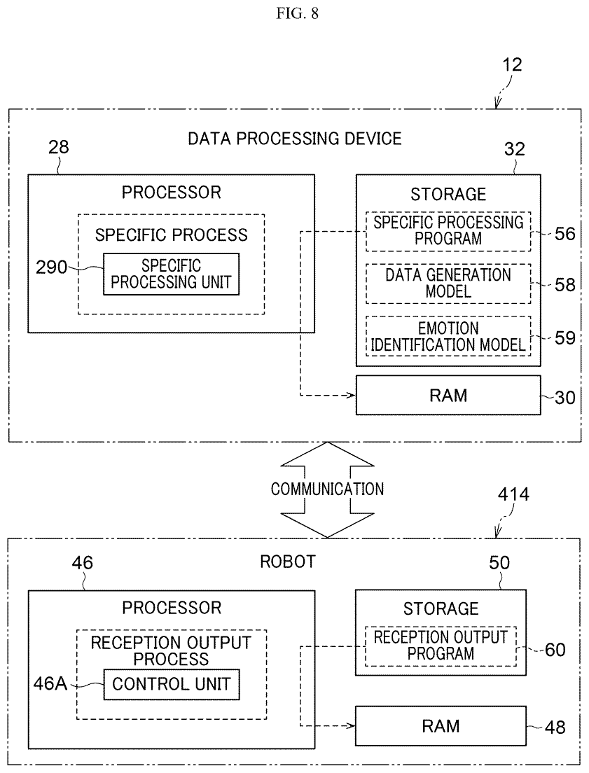

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

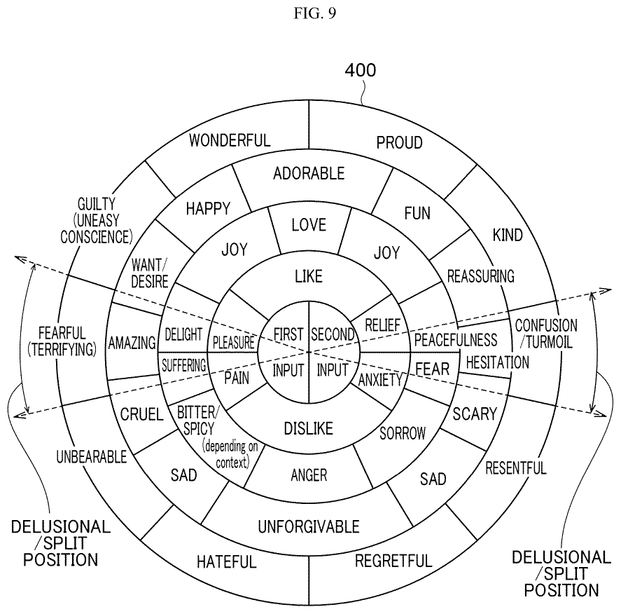

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

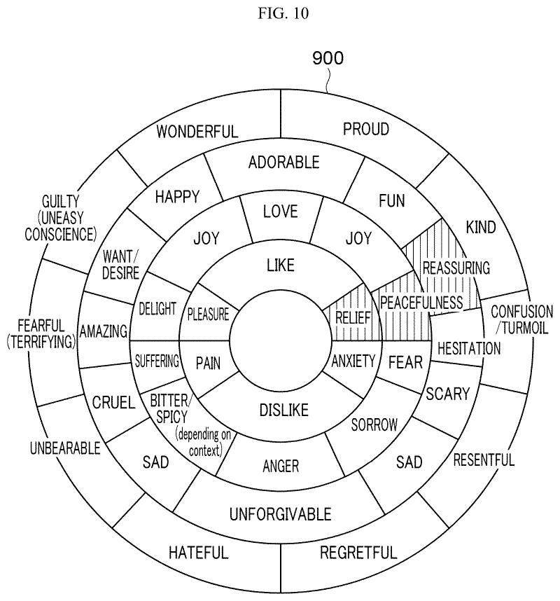

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive inquiry data transmitted from a user-side information processing apparatus via an electronic communication network,
store the inquiry data in the storage device and execute, by using an analysis program having a natural language processing function, word segmentation processing, part-of-speech tagging processing, important term extraction processing, and intent classification processing on the inquiry data so as to generate analysis result data,
construct, on the basis of the analysis result data and the inquiry data, a prompt sentence to be input to a generative information processing model, and transmit the prompt sentence to the generative information processing model so as to cause the generative information processing model to generate response text data,
execute content verification processing and format adjustment processing on the response text data, and store verified response data in the storage device,
transmit the verified response data via the electronic communication network to the user-side information processing apparatus so as to cause the verified response data to be presented through a display user interface of the user-side information processing apparatus, and
estimate an emotional state of a user from an expression included in at least one of the inquiry data and the response text data, and adjust an expression format of at least one of the prompt sentence and the response text data in accordance with the estimated emotional state.

### Supplementary 2

The system according to supplementary 1,
wherein the processor is configured to
add control information to the prompt sentence, the control information specifying at least one of a generation domain, a response style, and an output length constraint on the basis of an intent classification result and important terms included in the analysis result data, and cause the generative information processing model to generate the response text data in accordance with the control information.

### Supplementary 3

The system according to supplementary 1,
wherein the processor is configured to
store, in association with one another in the storage device, the inquiry data, the analysis result data, and the verified response data as a history, and dynamically update at least one of contents of the prompt sentence and an operation condition of the generative information processing model for subsequent inquiry data on the basis of the history.

### Application Example 1

### Supplementary 1

A system comprising a processor,
wherein the processor is configured to
receive inquiry information from a user terminal via a communication network,
normalize character information included in the inquiry information, analyze a character string of the inquiry information, and classify an intention of the inquiry to determine an inquiry type,
select, in accordance with the inquiry type, at least one explanation template from among a plurality of explanation templates stored in a storage medium, and construct a prompt sentence for a generative AI model based on the inquiry information and the selected explanation template,
acquire, from an information storage medium, facility information, item information, or guidance information associated with the inquiry type, and correct the prompt sentence by incorporating the facility information, the item information, or the guidance information into the prompt sentence,
input the corrected prompt sentence to a generative AI model and perform natural language processing to cause the generative AI model to generate response information or guidance information corresponding to the inquiry information,
generate display information including at least one of position information or floor information of a presentation target based on contents of the response information or the guidance information and based on the inquiry type, and
transmit the display information to the user terminal via the communication network so that the display information is presented to a user on the user terminal.

### Supplementary 2

The system according to supplementary 1,
wherein the processor is configured to
determine, based on a result of determining the inquiry type, at least one of a popularity-related inquiry, a location-related inquiry, and a sales-condition-related inquiry, and construct the prompt sentence by using an explanation template that is different for each determined inquiry type.

### Supplementary 3

The system according to supplementary 1,
wherein the processor is configured to
compare the response information or the guidance information obtained from the generative AI model with the facility information, the item information, or the guidance information acquired from the information storage medium, and, when an inconsistency is present between them, correct the response information or the guidance information based on the information acquired from the information storage medium.

### Example 2

### Supplementary 1

A system comprising a processor,
wherein the processor is configured to
receive, via a communication network, an information request expressed in natural language from a user terminal, and extract inquiry information to be analyzed from the received information request, and
generate a prompt sentence using the inquiry information as input, and input the prompt sentence to a generative AI model to obtain analysis result information including an intent, a target event, and a condition of the inquiry information by natural language processing, and generate a query request to an information storage device as an information source based on the analysis result information, and acquire target data related to the information request from the information storage device by using a structured query language, and
generate a prompt sentence using the target data and the inquiry information as input, and
input the prompt sentence to a generative AI model to generate response information in natural language to be presented to a user, and
transmit the response information to the user terminal via the communication network and cause the response information to be output to the user through display processing in the user terminal.

### Supplementary 2

The system according to supplementary 1,
wherein the processor is configured to specify an output format in the prompt sentence such that the generative AI model outputs the analysis result information in a machine-readable format, and dynamically generate the query request to the information storage device in the structured query language according to the machine-readable format.

### Supplementary 3

The system according to supplementary 1,
wherein the information storage device is configured to store an information set including attribute information regarding public services or public facilities, and the generative AI model is configured to generate the response information, based on the information set, in a format and an expression that are easy for the user to understand.

### Application Example 2

### Supplementary 1

A system comprising a processor,
wherein the processor is configured to
receive inquiry information transmitted from a user terminal via a communication network, perform preprocessing on text data included in the received inquiry information and perform language analysis on the text data to generate structured data representing an intent of the inquiry and target information of the inquiry,
perform emotion analysis processing on the text data to generate emotion data indicating an emotional state of a user,
search an information storage device for information resources based on the structured data and acquire information data related to the inquiry,
generate a prompt sentence including the text data, the structured data, the emotion data, and the information data, and supply the prompt sentence as input to a generative AI model so as to cause the generative AI model to generate answer text,
generate response data by adjusting an expression format or a presentation order of the answer text according to the emotion data, and
transmit the response data to the user terminal and provide the response data as response information for display or audio output.

### Supplementary 2

The system according to supplementary 1,
wherein the processor is configured to
generate the prompt sentence by explicitly including in the prompt sentence a user inquiry content, the structured data indicating the intent of the inquiry and the target information, the information data acquired from the information storage device, and the emotion data indicating the emotional state of the user, and by adding to the prompt sentence a task description including instructions for a language, a length, and a tone of the answer text to be generated by the generative AI model.

### Supplementary 3

The system according to supplementary 1,
wherein the processor is configured to
reconstruct the answer text such that, when the emotion data includes an index indicating urgency of the user, main numerical information or important items in the answer text are arranged at a beginning of the answer text according to the index, and to add presentation control information for causing the reconstructed answer text to be emphasized on a display of the user terminal.

What is claimed is:

1. A system comprising:
circuitry configured to:
receive inquiry information from a user terminal via a communication network;
normalize character information included in the inquiry information and analyze a character string of the inquiry information to classify an intention of the inquiry and determine an inquiry type;
select, in accordance with the inquiry type, at least one explanation template from among a plurality of explanation templates stored in a storage medium;
construct a prompt sentence for a generative artificial intelligence model based on the inquiry information and the selected explanation template;
acquire, from an information storage medium, at least one of facility information, item information, or guidance information associated with the inquiry type, and incorporate the acquired information into the prompt sentence to generate a corrected prompt sentence;
input the corrected prompt sentence to the generative artificial intelligence model to obtain response information corresponding to the inquiry information;
compare the response information with the facility information, the item information, or the guidance information acquired from the information storage medium, and, when an inconsistency is detected between the response information and the acquired information, correct the response information based on the acquired information; and
generate display information including at least one of position information or floor information of a presentation target based on contents of the corrected response information and the inquiry type, and transmit the display information to the user terminal.

2. The system of claim 1, wherein the circuitry is configured to:
apply an emotion recognition model to the inquiry information to determine an emotional state of a user; and
adjust at least one of a content structure, a degree of detail, or a response style of the response information based on the determined emotional state.

3. The system of claim 2, wherein the emotion recognition model applies a transformer-based sentiment classifier to extract emotion features from character information in the inquiry information and maps the emotion features to an emotional state category comprising at least one of a frustrated state, a confused state, an anxious state, and an urgent state.

4. The system of claim 3, wherein adjusting the content structure based on the emotional state comprises selecting a response formatting template that specifies section order, section inclusion, and degree of detail for the response information, wherein the response formatting template is selected from a plurality of formatting templates indexed by emotional state category.

5. The system of claim 4, wherein the circuitry is configured to:
incorporate the emotional state category into the corrected prompt sentence as an additional instruction parameter that directs the generative artificial intelligence model to generate response information in a tone and structure appropriate for the emotional state category.

6. The system of claim 1, wherein normalizing the character information comprises applying at least one of Unicode normalization, punctuation standardization, and whitespace normalization to convert the character information into a standardized character sequence.

7. The system of claim 6, wherein classifying the intention of the inquiry comprises applying a multi-class intent classification model to the standardized character sequence to generate a probability distribution over a predefined set of inquiry type classes, and assigning the inquiry type as the class with the highest probability.

8. The system of claim 7, wherein the intent classification model applies transformer-based self-attention over a token sequence derived from the standardized character sequence to compute intent class probabilities.

9. The system of claim 1, wherein constructing the prompt sentence comprises embedding the inquiry information and content of the selected explanation template into a structured prompt format that instructs the generative artificial intelligence model to generate response information scoped to a domain defined by the inquiry type.

10. The system of claim 9, wherein the structured prompt format includes an instruction section specifying an output format constraint and a context section containing the facility information, the item information, or the guidance information acquired from the information storage medium.

11. The system of claim 1, wherein comparing the response information with the acquired information comprises applying a consistency checking algorithm that identifies tokens in the response information that contradict stored attribute values in the facility information, the item information, or the guidance information.

12. The system of claim 11, wherein correcting the response information based on the acquired information comprises replacing tokens identified as contradicting stored attribute values with corresponding values retrieved from the information storage medium.

13. The system of claim 1, wherein the display information comprises structured data encoding at least one of a floor number, a zone identifier, a room identifier, or a navigation path derived from the position information or the floor information of the presentation target.

14. The system of claim 13, wherein generating the display information comprises applying a template mapping inquiry type to a display layout format that specifies which of position information, floor information, and guidance text to include in the display information.

15. The system of claim 1, wherein the plurality of explanation templates are indexed by inquiry type in the storage medium, and wherein selecting the explanation template comprises executing a lookup operation using the determined inquiry type as a key.

16. The system of claim 1, wherein the generative artificial intelligence model is a large language model accessed via a network interface, and wherein the corrected prompt sentence is transmitted to the generative artificial intelligence model as a prompt request payload via an application programming interface.

17. The system of claim 2, wherein the circuitry is configured to:
update a response history record in the storage medium based on the transmitted display information, associating the inquiry type, the emotional state, and the display information for use in subsequent prompt construction.

18. A system comprising:
circuitry configured to:
receive inquiry information from a user terminal and normalize character information included in the inquiry information;
apply a multi-class intent classification model to the normalized character information to determine an inquiry type and select at least one explanation template from among a plurality of explanation templates stored in a storage medium based on the inquiry type;
construct a prompt sentence based on the inquiry information and the selected explanation template, incorporate at least one of facility information, item information, or guidance information from an information storage medium into the prompt sentence to generate a corrected prompt sentence, and input the corrected prompt sentence to a generative artificial intelligence model to obtain response information;
compare the response information with the facility information, the item information, or the guidance information and correct the response information when an inconsistency is detected; and
apply an emotion recognition model to the inquiry information to determine an emotional state and adjust at least one of a content structure, a degree of detail, or a response style of the response information based on the determined emotional state.

19. The system of claim 18, wherein the circuitry is configured to apply a consistency checking algorithm that identifies tokens in the response information contradicting stored attribute values in the facility information, the item information, or the guidance information, and to replace the identified tokens with corresponding values retrieved from the information storage medium.

20. A method performed by circuitry, the method comprising:
receiving inquiry information from a user terminal via a communication network;
normalizing character information included in the inquiry information and applying a multi-class intent classification model to determine an inquiry type;
selecting at least one explanation template from among a plurality of explanation templates based on the inquiry type and constructing a prompt sentence based on the inquiry information and the selected explanation template;
incorporating at least one of facility information, item information, or guidance information associated with the inquiry type into the prompt sentence to generate a corrected prompt sentence;
inputting the corrected prompt sentence to a generative artificial intelligence model to obtain response information;
applying an emotion recognition model to the inquiry information to determine an emotional state and adjusting at least one of a content structure, a degree of detail, or a response style of the response information based on the emotional state; and
generating display information including at least one of position information or floor information of a presentation target and transmitting the display information to the user terminal.
